(19) United States
(12) Patent Application Publication
(10) Pub. No.: US 2012/0069148 A1
(43) Pub. Date: Mar. 22, 2012

(54) IMAGE PRODUCTION DEVICE, IMAGE PRODUCTION METHOD, PROGRAM, AND STORAGE MEDIUM STORING PROGRAM

(75) Inventors: Yuki Ueda, Osaka (JP); Mitsuyoshi Okamoto, Osaka (JP)

(73) Assignee: Panasonic Corporation, Osaka (JP)

(21) Appl. No.: 13/079,017

(22) Filed: Apr. 4, 2011

(30) Foreign Application Priority Data
Sep. 17, 2010 (JP) 2010-210213
Jan. 21, 2011 (JP) 2011-010807

(51) Int. Cl. H04N 13/02

(52) U.S. Cl. 348/46; 348/E13.074

(57) ABSTRACT

The image production device includes a deviation detecting device and an information production section. The deviation detecting device is configured to calculate the amount of relative deviation of left-eye image data and right-eye image data included with input image data. The information production section is configured to produce evaluation information related to the suitability of three-dimensional imaging based on reference information produced by the deviation detecting device which calculates the relative deviation amount.

### CROSS-REFERENCE TO RELATED APPLICATIONS

This application claims priority under 35 U.S.C. §119 to Japanese Patent Application No. 2010-210213, filed on Sep. 17, 2010, and Japanese Patent Application No. 2011-010807, filed on Jan. 21, 2011. The entire disclosures of Japanese Patent Applications No. 2010-210213 and No. 2011-010807 are hereby incorporated herein by reference.

### BACKGROUND

1. Technical Field

The technology disclosed herein relates to an image production device, an image production method, a program, and a storage medium storing a program.

2. Background Information

An example of a known image production device is a digital camera or other such imaging device. A digital camera has an imaging element such as a CCD (charge coupled device) image sensor or a CMOS (complementary metal oxide semiconductor) image sensor. The imaging element converts an optical image formed by the optical system into an image signal. This allows image data about a subject to be acquired. Development has been underway in recent years into what are known as three-dimensional displays. Along with this, there has also been progress in the development of digital cameras that produce so-called stereo image data (image data used for a three-dimensional display that includes a left-eye image and a right-eye image).

To produce a stereo image having parallax, however, it is necessary to use an optical system for three-dimensional imaging (hereinafter also referred to as a three-dimensional optical system).

In view of this, a video camera has been proposed which automatically switches between two-dimensional imaging mode and three-dimensional imaging mode on the basis of whether or not a three-dimensional imaging adapter has been fitted (see, for example, Japanese Laid-Open Patent Application H07-274214).

Left- and right-eye optical systems are provided to a three-dimensional optical system, but individual differences between the left- and right-eye optical systems can produce relative deviation between the left- and right-eye optical images formed on the imaging element. If the left- and right-eye optical images diverge too much, there is too much deviation between the left- and right-eye images in the stereo image, and as a result, there is the possibility that the 3-D view will not be as good in a three-dimensional display.

### SUMMARY

One object of the technology disclosed herein is to provide an image production device and an image production method in which a better 3-D view can be obtained.

In accordance with one aspect of the technology disclosed herein, the image production device includes a deviation detecting device and an information production section. The deviation detecting device is configured to calculate the amount of relative deviation of left-eye image data and right-eye image data included with input image data. The information production section is configured to produce evaluation information related to the suitability of three-dimensional imaging based on reference information produced by the deviation detecting device which calculates the relative deviation amount.

The image production device disclosed herein also includes, in addition to an imaging device that captures images, a device that can read, write, and store image data that has already been acquired or that can produce new image data.

According to another aspect of the technology disclosed herein, an image production method is provided that includes calculating the amount of relative deviation of left-eye image data and right-eye image data included with input image data, and producing evaluation information related to the suitability of three-dimensional imaging based on reference information produced by a deviation detecting device configured to calculate the relative deviation amount.

These and other objects, features, aspects and advantages of the technology disclosed herein will become apparent to those skilled in the art from the following detailed description, which, taken in conjunction with the annexed drawings, discloses embodiments of the present invention.

### BRIEF DESCRIPTION OF DRAWINGS

Referring now to the attached drawings which form a part of this original disclosure:

FIG. 1 is an oblique view of a digital camera 1;

FIG. 2 is an oblique view of a camera body 100;

FIG. 3 is a rear view of a camera body 100;

FIG. 4 is a simplified block diagram of a digital camera 1;

FIG. 5 is a simplified block diagram of an interchangeable lens unit 200;

FIG. 6 is a simplified block diagram of a camera body 100;

FIG. 7A is an example of the configuration of lens identification information F1, FIG. 7B is an example of the configuration of lens characteristic information F2, and FIG. 7C is an example of the configuration of lens state information F3;

FIG. 8A is a time chart for a camera body and an interchangeable lens unit when the camera body is not compatible with three-dimensional imaging, and FIG. 8B is a time chart for a camera body and an interchangeable lens unit when the camera body and interchangeable lens unit are compatible with three-dimensional imaging;

FIG. 9 is a diagram illustrating various parameters;

FIG. 10 is a diagram illustrating various parameters;

FIG. 11 is a diagram illustrating pattern matching processing;

FIG. 12 is a flowchart of when the power is on;

FIG. 13 is a flowchart of when the power is on;

FIG. 14 is a flowchart of during imaging (first embodiment);

FIG. 15 is a flowchart of during imaging (first embodiment);

FIG. 16 is a flowchart of evaluation flag identification processing during three-dimensional imaging (first embodiment);

FIG. 17 is an example of a warning display;

FIG. 18 is a flowchart of evaluation flag production processing (second embodiment);

FIG. 19 is a flowchart of evaluation flag production processing (second embodiment); and

FIG. 20 is a diagram illustrating pattern matching processing (second embodiment).

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

### Configuration of Digital Camera

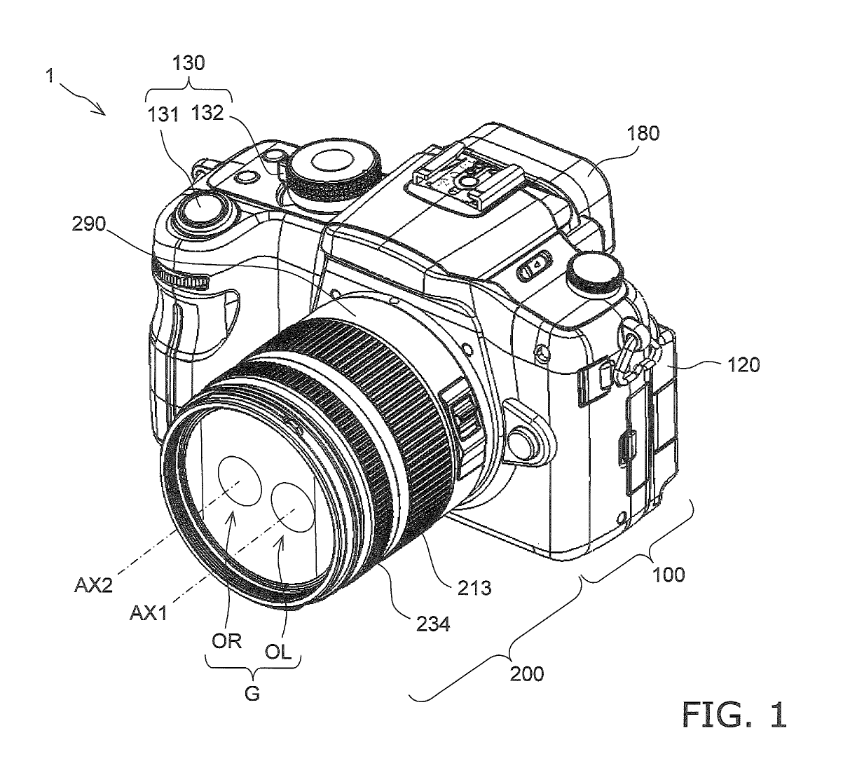

A digital camera 1 is an imaging device capable of three-dimensional imaging, and is an interchangeable lens type of digital camera. As shown in FIGS. 1 to 3, the digital camera 1 comprises an interchangeable lens unit 200 and a camera body 100 to which the interchangeable lens unit 200 can be mounted. The interchangeable lens unit 200 is a lens unit that is compatible with three-dimensional imaging, and forms optical images of a subject (a left-eye optical image and a right-eye optical image). The camera body 100 is compatible with both two- and three-dimensional imaging, and produces image data on the basis of the optical image formed by the interchangeable lens unit 200. In addition to the interchangeable lens unit 200 that is compatible with three-dimensional imaging, an interchangeable lens unit that is not compatible with three-dimensional imaging can also be attached to the camera body 100. That is, the camera body 100 is compatible with both two- and three-dimensional imaging.

For the sake of convenience in the following description, the subject side of the digital camera 1 will be referred to as “front,” the opposite side from the subject as “back” or “rear,” the vertical upper side in the normal orientation (landscape orientation) of the digital camera 1 as “upper,” and the vertical lower side as “lower.”

1: Interchangeable Lens Unit

The interchangeable lens unit 200 is a lens unit that is compatible with three-dimensional imaging. The interchangeable lens unit 200 in this embodiment makes use of a side-by-side imaging system with which two optical images are formed on a single imaging element by a pair of left and right optical systems.

As shown in FIGS. 1 to 4, the interchangeable lens unit 200 has a three-dimensional optical system a first drive unit 271, a second drive unit 272, a shake amount detecting sensor 275, and a lens controller 240. The interchangeable lens unit 200 further has a lens mount 250, a lens barrel 290, a zoom ring 213, and a focus ring 234. In the mounting of the interchangeable lens unit 200 to the camera body 100, the lens mount 250 is attached to a body mount 150 (discussed below) of the camera body 100. As shown in FIG. 1, the zoom ring 213 and the focus ring 234 are rotatably provided to the outer part of the lens barrel 290.

(1) Three-Dimensional Optical System G

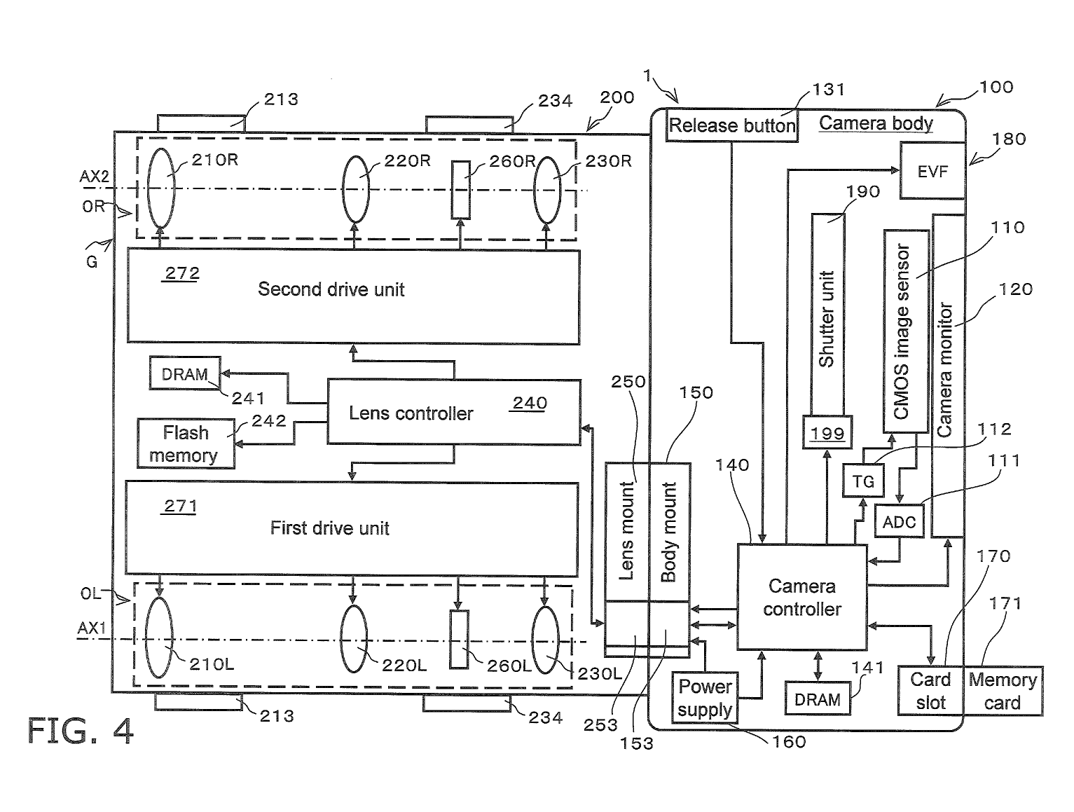

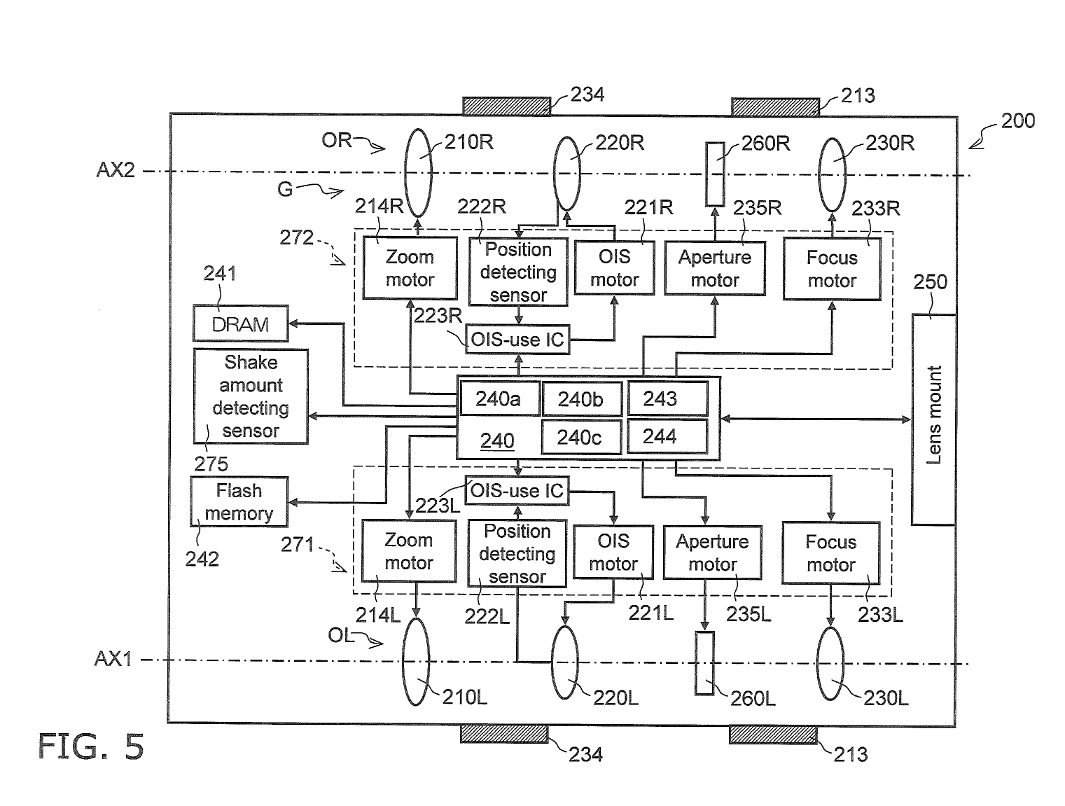

As shown in FIGS. 4 and 5, the three-dimensional optical system G is an optical system compatible with side-by-side imaging, and has a left-eye optical system OL and a right-eye optical system OR. The left-eye optical system OL and the right-eye optical system OR are disposed to the left and right of each other. Here, “left-eye optical system” refers to an optical system corresponding to a left-side perspective, and more specifically refers to an optical system in which the optical element disposed closest to the subject (the front side) is disposed on the left side facing the subject. Similarly, a “right-eye optical system” refers to an optical system corresponding to a right-side perspective, and more specifically refers to an optical system in which the optical element disposed closest to the subject (the front side) is disposed on the right side facing the subject.

The left-eye optical system OL is an optical system used to capture an image of a subject from a left-side perspective facing the subject, and includes a zoom lens 210L, an OIS lens 220L, an aperture unit 260L, and a focus lens 230L. The left-eye optical system OL has a first optical axis AX1, and is housed inside the lens barrel 290 in a state of being side by side with the right-eye optical system OR.

The zoom lens 210L is used to change the focal length of the left-eye optical system OL, and is disposed movably in a direction parallel with the first optical axis AX1. The zoom lens 210L is made up of one or more lenses. The zoom lens 210L is driven by a zoom motor 214L (discussed below) of the first drive unit 271. The focal length of the left-eye optical system OL can be adjusted by driving the zoom lens 210L in a direction parallel with the first optical axis AX1.

The OIS lens 220L is used to suppress displacement of the optical image formed by the left-eye optical system OL with respect to a CMOS image sensor 110 (discussed below). The OIS lens 220L is made up of one or more lenses. An OIS motor 221L drives the OIS lens 220L on the basis of a control signal sent from an OIS-use IC 223L so that the OIS lens 220L moves within a plane perpendicular to the first optical axis AX1. The OIS motor 221L can be, for example, a magnet (not shown) and a flat coil (not shown). The position of the OIS lens 220L is detected by a position detecting sensor 222L (discussed below) of the first drive unit 271.

An optical system is employed as the blur correction system in this embodiment, but the blur correction system may instead be an electronic system in which image data produced by the CMOS image sensor 110 is subjected to correction processing, or a sensor shift system in which an imaging element such as the CMOS image sensor 110 is driven within a plane that is perpendicular to the first optical axis AX1.

The aperture unit 260L adjusts the amount of light that passes through the left-eye optical system OL. The aperture unit 260L has a plurality of aperture vanes (not shown). The aperture vanes are driven by an aperture motor 235L (discussed below) of the first drive unit 271. A camera controller 140 (discussed below) controls the aperture motor 235L.

The focus lens 230L is used to adjust the subject distance (also called the object distance) of the left-eye optical system OL, and is disposed movably in a direction parallel to the first optical axis AX1. The focus lens 230L is driven by a focus motor 233L (discussed below) of the first drive unit 271. The focus lens 230L is made up of one or more lenses.

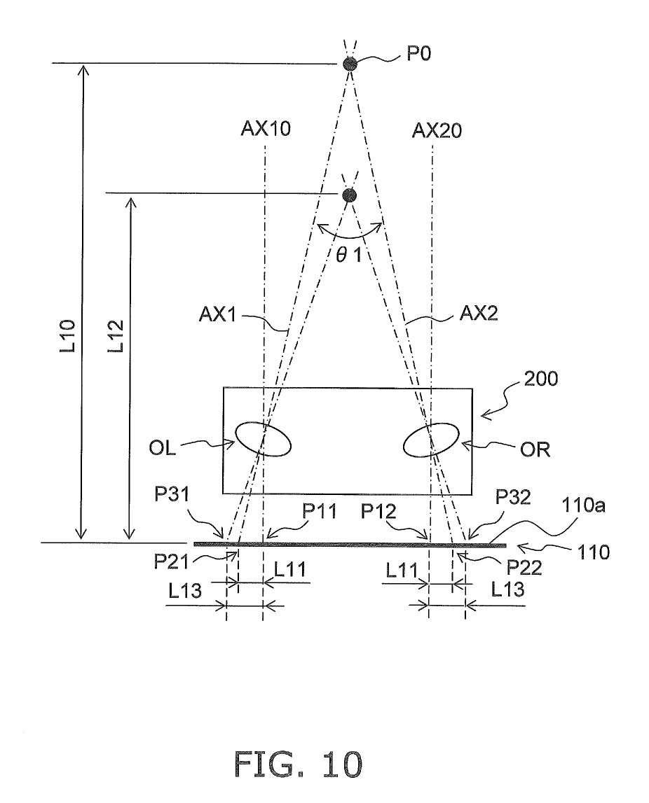

The right-eye optical system OR is an optical system used to capture an image of a subject from a right-side perspective facing the subject, and includes a zoom lens 210R, an OIS lens 220R, an aperture unit 260R, and a focus lens 230R. The right-eye optical system OR has a second optical axis AX2, and is housed inside the lens barrel 290 in a state of being side by side with the left-eye optical system OL. The spec of the right-eye optical system OR is the same as the spec of the left-eye optical system OL. The angle formed by the first optical axis AX1 and the second optical axis AX2 (angle of convergence) is referred to as the angle θ1 shown in FIG. 10.

The zoom lens 210R is used to change the focal length of the right-eye optical system OR, and is disposed movably in a direction parallel with the second optical axis AX2. The zoom lens 210R is made up of one or more lenses. The zoom lens 210R is driven by a zoom motor 214R (discussed below) of the second drive unit 272. The focal length of the right-eye optical system OR can be adjusted by driving the zoom lens 210R in a direction parallel with the second optical axis AX2. The drive of the zoom lens 210R is synchronized with the drive of the zoom lens 210L. Therefore, the focal length of the right-eye optical system OR is the same as the focal length of the left-eye optical system OL.

The OIS lens 220R is used to suppress displacement of the optical image formed by the right-eye optical system OR with respect to the CMOS image sensor 110. The OIS lens 220R is made up of one or more lenses. An OIS motor 221R drives the OIS lens 220R on the basis of a control signal sent from an OIS-use IC 223R so that the OIS lens 220R moves within a plane perpendicular to the second optical axis AX2. The OIS motor 221R can be, for example, a magnet (not shown) and a flat coil (not shown). The position of the OIS lens 220R is detected by a position detecting sensor 222R (discussed below) of the second drive unit 272.

An optical system is employed as the blur correction system in this embodiment, but the blur correction system may instead be an electronic system in which image data produced by the CMOS image sensor 110 is subjected to correction processing, or a sensor shift system in which an imaging element such as the CMOS image sensor 110 is driven within a plane that is perpendicular to the second optical axis AX2.

The aperture unit 260R adjusts the amount of light that passes through the right-eye optical system OR. The aperture unit 260R has a plurality of aperture vanes (not shown). The aperture vanes are driven by an aperture motor 235R (discussed below) of the second drive unit 272. The camera controller 140 controls the aperture motor 235R. The drive of the aperture unit 260R is synchronized with the drive of the aperture unit 260L. Therefore, the aperture value of the right-eye optical system OR is the same as the aperture value of the left-eye optical system OL.

The focus lens 230R is used to adjust the subject distance (also called the object distance) of the right-eye optical system OR, and is disposed movably in a direction parallel to the second optical axis AX2. The focus lens 230R is driven by a focus motor 233R (discussed below) of the second drive unit 272. The focus lens 230R is made up of one or more lenses.

(2) First Drive Unit 271

The first drive unit 271 is provided to adjust the state of the left-eye optical system OL, and as shown in FIG. 5, has the zoom motor 214L, the OIS motor 221L, the position detecting sensor 222L, the OIS-use IC 223L, the aperture motor 235L, and the focus motor 233L.

The zoom motor 214L drives the zoom lens 210L. The zoom motor 214L is controlled by the lens controller 240.

The OIS motor 221L drives the OIS lens 220L. The position detecting sensor 222L is a sensor for detecting the position of the OIS lens 220L. The position detecting sensor 222L is a Hall element, for example, and is disposed near the magnet of the OIS motor 221L. The OIS-use IC 223L controls the OIS motor 221L on the basis of the detection result of the position detecting sensor 222L and the detection result of the shake amount detecting sensor 275. The OIS-use IC 223L acquires the detection result of the shake amount detecting sensor 275 from the lens controller 240. Also, the OIS-use IC 223L sends the lens controller 240 a signal indicating the position of the OIS lens 220L, at a specific period.

The aperture motor 235L drives the aperture unit 260L. The aperture motor 235L is controlled by the lens controller 240.

The focus motor 233L drives the focus lens 230L. The focus motor 233L is controlled by the lens controller 240. The lens controller 240 also controls the focus motor 233R, and synchronizes the focus motor 233L and the focus motor 233R. Consequently, the subject distance of the left-eye optical system OL is the same as the subject distance of the right-eye optical system OR. Examples of the focus motor 233L include a DC motor, a stepping motor, a servo motor, and an ultrasonic motor.

(3) Second Drive Unit 272

The second drive unit 272 is provided to adjust the state of the right-eye optical system OR, and as shown in FIG. 5, has the zoom motor 214R, the OIS motor 221R, the position detecting sensor 222R, the OIS-use IC 223R, the aperture motor 235R, and the focus motor 233R.

The zoom motor 214R drives the zoom lens 210R. The zoom motor 214R is controlled by the lens controller 240.

The OIS motor 221R drives the OIS lens 220R. The position detecting sensor 222R is a sensor for detecting the position of the OIS lens 220R. The position detecting sensor 222R is a Hall element, for example, and is disposed near the magnet of the OIS motor 221R. The OIS-use IC 223R controls the OIS motor 221R on the basis of the detection result of the position detecting sensor 222R and the detection result of the shake amount detecting sensor 275. The OIS-use IC 223R acquires the detection result of the shake amount detecting sensor 275 from the lens controller 240. Also, the OIS-use IC 223R sends the lens controller 240 a signal indicating the position of the OIS lens 220R, at a specific period.

The aperture motor 235R drives the aperture unit 260R. The aperture motor 235R is controlled by the lens controller 240.

The focus motor 233R drives the focus lens 230R. The focus motor 233R is controlled by the lens controller 240. The lens controller 240 synchronizes the focus motor 233L and the focus motor 233R. Consequently, the subject distance of the left-eye optical system OL is the same as the subject distance of the right-eye optical system OR. Examples of the focus motor 233R include a DC motor, a stepping motor, a servo motor, and an ultrasonic motor.

(4) Lens Controller 240

The lens controller 240 controls the various components of the interchangeable lens unit 200 (such as the first drive unit 271 and the second drive unit 272) on the basis of control signals sent from the camera controller 140. The lens controller 240 sends and receives signals to and from the camera controller 140 via the lens mount 250 and the body mount 150. During control, the lens controller 240 uses a DRAM 241 as a working memory.

The lens controller 240 has a CPU (central processing unit) 240a, a ROM (read only memory) 240b, and a RAM (random access memory) 240c, and can perform various functions by reading programs stored in the ROM 240b into the CPU 240a.

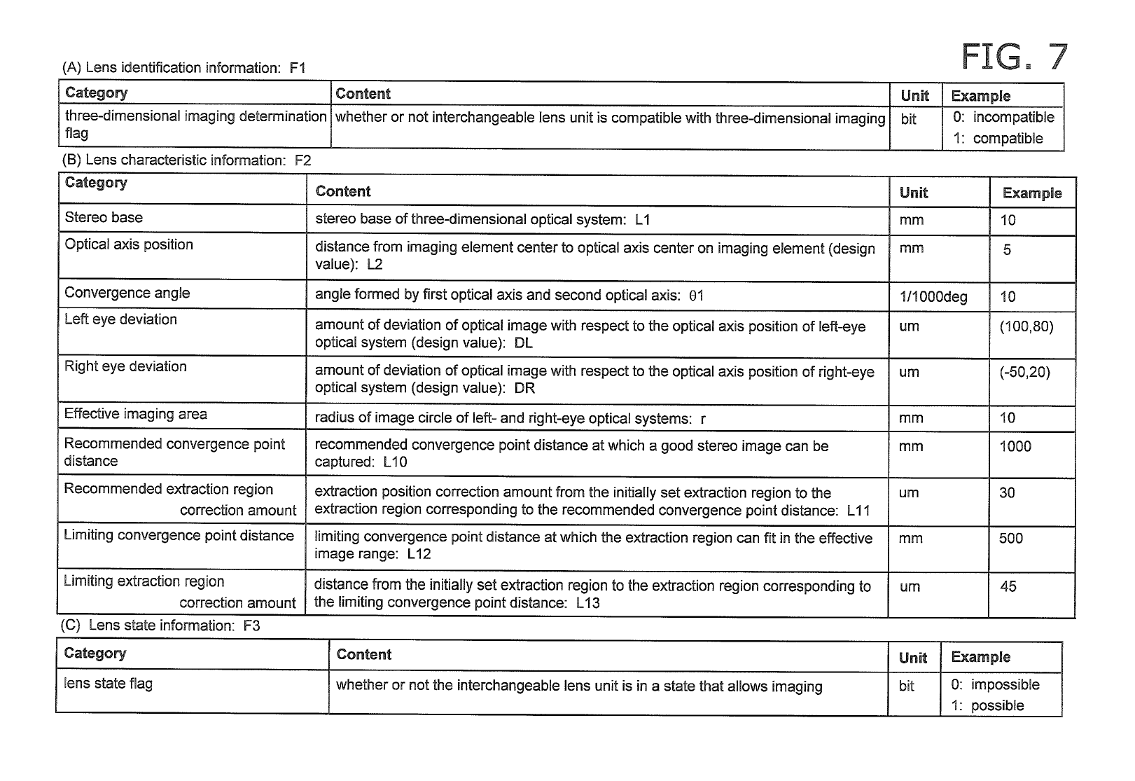

Also, a flash memory 242 (an example of a correction information storage section, and an example of an identification information storage section) stores parameters or programs used in control by the lens controller 240. For example, in the flash memory 242 are pre-stored lens identification information F1 (see FIG. 7A) indicating that the interchangeable lens unit 200 is compatible with three-dimensional imaging, and lens characteristic information F2 (see FIG. 7B) that includes flags and parameters indicating the characteristics of the three-dimensional optical system G Lens state information F3 (see FIG. 7C) indicating whether or not the interchangeable lens unit 200 is in a state that allows imaging is held in the RAM 240c, for example.

The lens identification information FL lens characteristic information F2, and lens state information F3 will now be described.

Lens Identification Information F1

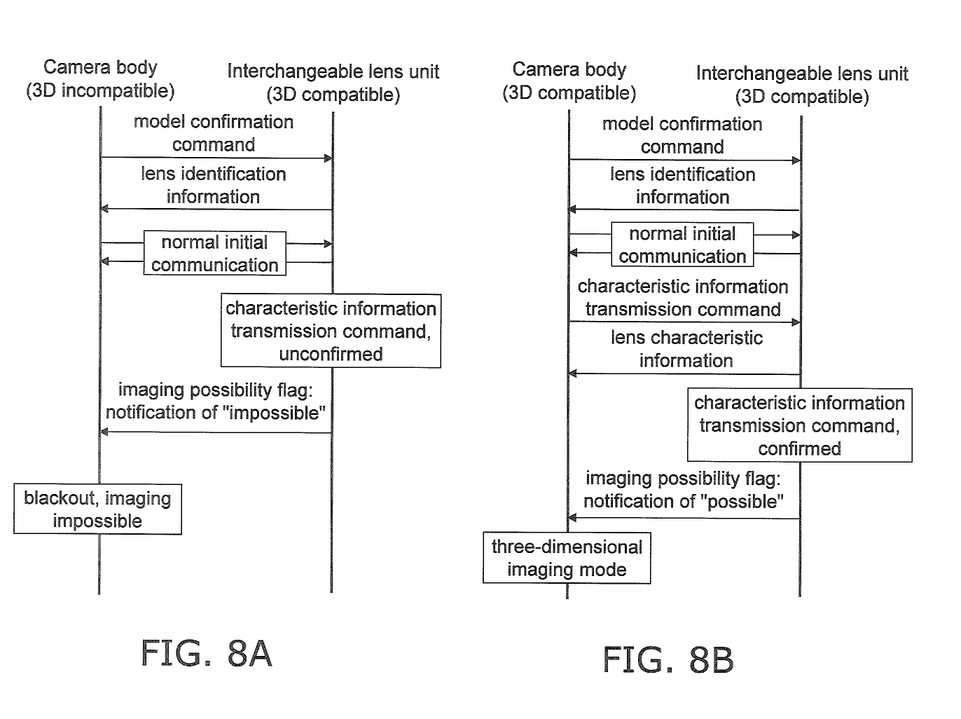

The lens identification information F1 is information indicating whether or not the interchangeable lens unit is compatible with three-dimensional imaging, and is stored ahead of time in the flash memory 242, for example. As shown in FIG. 7A, the lens identification information F1 is a three-dimensional imaging determination flag stored at a specific address in the flash memory 242. As shown in FIGS. 8A and 8B, a three-dimensional imaging determination flag is sent from the interchangeable lens unit to the camera body in the initial communication performed between the camera body and the interchangeable lens unit when the power is turned on or when the interchangeable lens unit is mounted to the camera body.

If a three-dimensional imaging determination flag has been raised, that interchangeable lens unit is compatible with three-dimensional imaging, but if a three-dimensional imaging determination flag has not been raised, that interchangeable lens unit is not compatible with three-dimensional imaging. A region not used for an ordinary interchangeable lens unit that is not compatible with three-dimensional imaging is used for the address of the three-dimensional imaging determination flag. Consequently, with an interchangeable lens unit that is not compatible with three-dimensional imaging, a state may result in which a three-dimensional imaging determination flag is not raised even though no setting of a three-dimensional imaging determination flag has been performed.

Lens Characteristic Information F2

The lens characteristic information F2 is data indicating the characteristics of the optical system of the interchangeable lens unit, and includes the following parameters and flags, as shown in FIG. 7B.

(A) Stereo Base

Stereo base L1 of the stereo optical system (G)

(B) Optical Axis Position

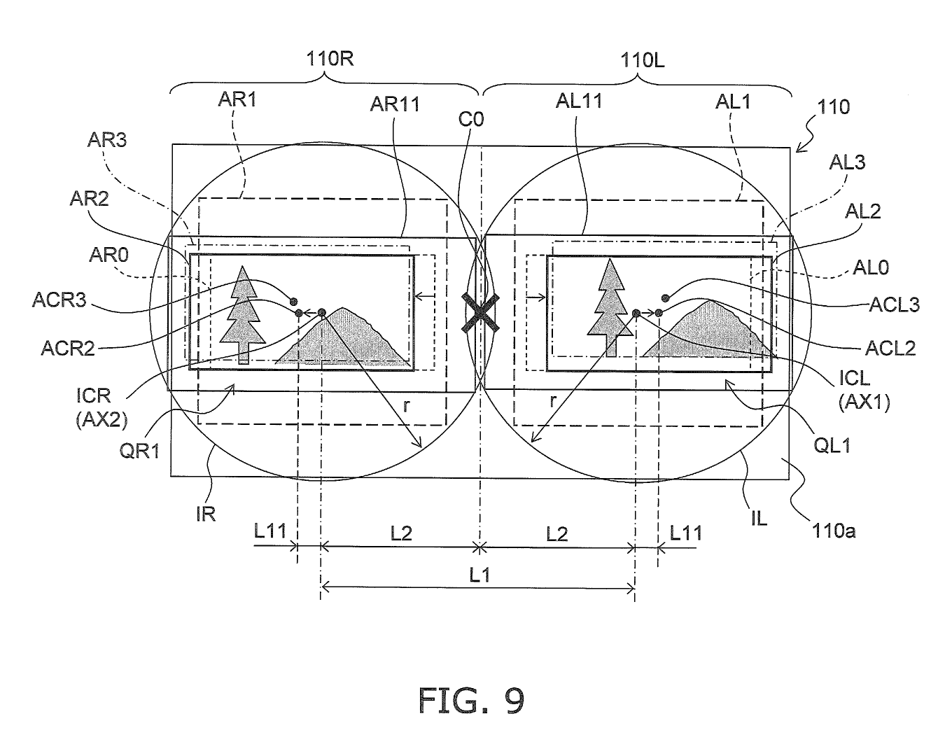

Distance L2 (design value) from the center CO (see FIG. 9) of the imaging element (the CMOS image sensor 110) to the optical axis center (the center ICR of the image circle IR or the center ICL or the image circle IL shown in FIG. 9)

(C) Angle of Convergence

Angle θ1 formed by the first optical axis (AX1) and the second optical axis (AX2) (see FIG. 10)

(D) Amount of Left-Eye Deviation

Deviation amount DL (horizontal: DLx, vertical: DLy) of the left-eye optical image (QL1) with respect to the optical axis position (design value) of the left-eye optical system (OL) on the imaging element (the CMOS image sensor 110)

(E) Amount of Right-Eye Deviation

Deviation amount DR (horizontal: DRx, vertical: DRy) of the right-eye optical image (QR1) with respect to the optical axis position (design value) of the right-eye optical system (OR) on the imaging element (the CMOS image sensor 110)

(F) Effective Imaging Area

Radius r of the image circles (AL1, AR1) of the left-eye optical system (OL) and the right-eye optical system (OR) (see FIG. 8)

(G) Recommended Convergence Point Distance

Distance L10 from the subject (convergence point P0) to the light receiving face 110a of the CMOS image sensor 110, recommended in performing three-dimensional imaging with the interchangeable lens unit 200 (see FIG. 10)

(H) Extraction Position Correction Amount

Distance L11 from the points (P11 and P12) at which the first optical axis AX1 and the second optical axis AX2 reach the light receiving face 110a when the convergence angle θ1 is zero, to the points (P21 and P22) at which the first optical axis AX1 and the second optical axis AX2 reach the light receiving face 110a when the convergence angle θ1 corresponds to the recommended convergence point distance L1 (see FIG. 10) (Also referred to as the “distance on the imaging element from the reference image extraction position corresponding to when the convergence point distance is at infinity, to the recommended image extraction position corresponding to the recommended convergence point distance of the interchangeable lens unit.”)

(G) Limiting Convergence Point Distance

Limiting distance L12 from the subject to the light receiving face 110a when the extraction range of the left-eye optical image QL1 and the right-eye optical image QR1 are both within the effective imaging area in performing three-dimensional imaging with the interchangeable lens unit 200 (see FIG. 10).

(H) Extraction Position Limiting Correction Amount

Distance L13 from the points (P11 and P12) at which the first optical axis AX1 and the second optical axis AX2 reach the light receiving face 110a when the convergence angle θ1 is zero, to the points (P31 and P32) at which the first optical axis AX1 and the second optical axis AX2 reach the light receiving face 110a when the convergence angle θ1 corresponds to the limiting convergence point distance L12 (see FIG. 10)

Of the above parameters, the optical axis position, the left-eye deviation, and the right-eye deviation are parameters characteristic of a side-by-side imaging type of three-dimensional optical system.

The above parameters will now be described through reference to FIGS. 9 and 10. FIG. 9 is a diagram of the CMOS image sensor 110 as viewed from the subject side. The CMOS image sensor 110 has a light receiving face 110a (see FIGS. 9 and 10) that receives light that has passed through the interchangeable lens unit 200. An optical image of the subject is formed on the light receiving face 110a. As shown in FIG. 9, the light receiving face 110a has a first region 110L and a second region 110R disposed adjacent to the first region 110L. The surface area of the first region 110L is the same as the surface area of the second region 110R. As shown in FIG. 9, when viewed from the rear face side of the camera body 100 (a see-through view), the first region 110L accounts for the left half of the light receiving face 110a, and the second region 110R accounts for the right half of the light receiving face 110a. As shown in FIG. 9, when imaging is performed using the interchangeable lens unit 200, a left-eye optical image QL1 is formed in the first region 110L, and a right-eye optical image QR1 is formed in the second region 110R.

As shown in FIG. 9, the image circle IL of the left-eye optical system OL and the image circle IR of the right-eye optical system OR are defined for design purposes on the CMOS image sensor 110. The center ICL of the image circle IL (an example of a reference image extraction position) coincides with the designed position of the first optical axis AX10 of the left-eye optical system OL, and the center ICR of the image circle IR (an example of a reference image extraction position) coincides with the designed position of the second optical axis AX20 of the right-eye optical system OR. Here, the “designed position” corresponds to a case in which the first optical axis AX10 and the second optical axis AX20 have their convergence point at infinity. Therefore, the designed stereo base is the designed distance L1 between the first optical axis AX10 and the second optical axis AX20 on the CMOS image sensor 110. Also, the optical axis position is the designed distance L2 between the center CO of the light receiving face 110a and the first optical axis AX10 (or the designed distance L2 between the center CO and the second optical axis AX20).

As shown in FIG. 9, an extractable range AL1 and a horizontal imaging-use extractable range AL11 are set on the basis of the center ICL, and an extractable range AR1 and a horizontal imaging-use extractable range AR11 are set on the basis of the center ICR. Since the center ICL is set substantially at the center position of the first region 110L of the light receiving face 110a, wider extractable ranges AL1 and AL11 can be ensured within the image circle IL. Also, since the center ICR is set substantially at the center position of the second region 110R, wider extractable ranges AR1 and AR11 can be ensured within the image circle IR.

The extractable ranges AL0 and AR0 shown in FIG. 9 are regions serving as a reference in extracting left-eye image data and right-eye image data. The designed extractable range AL0 for left-eye image data is set using the center ICL of the image circle IL (or the first optical axis AX10) as a reference, and is positioned at the center of the extractable range AL1 Also, the designed extractable range AR0 for right-eye image data is set using the center ICR of the image circle IR (or the second optical axis AX20) as a reference, and is positioned at the center of the extractable range AR1.

However, since the optical axis centers ICL and ICR corresponding to a case in which the convergence point is at infinity, if the left-eye image data and right-eye image data are extracted using the extraction regions AL0 and AR0 as a reference, the position at which the subject is reproduced in 3-D view will be the infinity position. Therefore, if the interchangeable lens unit 200 is for close-up imaging at this setting (such as when the distance from the imaging position to the subject is about 1 meter), there will be a problem in that the subject will jump out from the screen too much within the three-dimensional image in 3-D view.

In view of this, with this camera body 100, the extraction region AR0 is shifted to the recommended extraction region AR3, and the extraction region AL0 to the recommended extraction region AL3, each by a distance L11, so that the distance from the user to the screen in 3-D view will be the recommended convergence point distance L10 of the interchangeable lens unit 200. The correction processing of the extraction area using the extraction position correction amount L11 will be described below.

2: Configuration of Camera Body

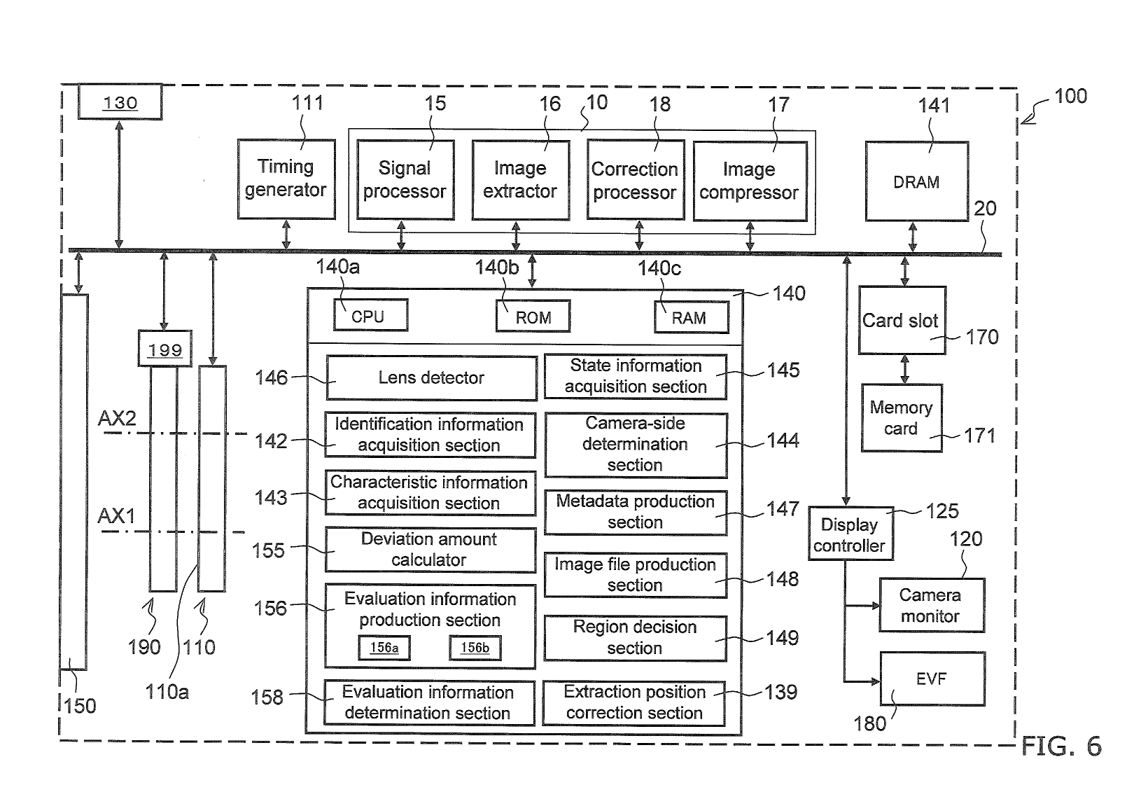

As shown in FIGS. 4 and 6, the camera body 100 comprises the CMOS image sensor 110, a camera monitor 120, an electronic viewfinder 180, a display controller 125, a manipulation unit 130, a card slot 170, a shutter unit 190, the body mount 150, a DRAM 141, an image processor 10, and the camera controller 140 (an example of a controller). These components are connected to a bus 20, allowing data to be exchanged between them via the bus 20.

(1) CMOS Image Sensor 110

The CMOS image sensor 110 converts an optical image of a subject (hereinafter also referred to as a subject image) formed by the interchangeable lens unit 200 into an image signal. As shown in FIG. 6, the CMOS image sensor 110 outputs an image signal on the basis of a timing signal produced by a timing generator 112. The image signal produced by the CMOS image sensor 110 is digitized and converted into image data by a signal processor 15 (discussed below). The CMOS image sensor 110 can acquire still picture data and moving picture data. The acquired moving picture data is also used for the display of a through-image.

The “through-image” referred to here is an image, out of the moving picture data, that is not recorded to a memory card 171. The through-image is mainly a moving picture, and is displayed on the camera monitor 120 or the electronic viewfinder (hereinafter also referred to as EVF) 180 in order to compose a moving picture or still picture.

As discussed above, the CMOS image sensor 110 has the light receiving face 110a (see FIGS. 6 and 9) that receives light that has passed through the interchangeable lens unit 200. An optical image of the subject is formed on the light receiving face 110a. As shown in FIG. 9, when viewed from the rear face side of the camera body 100, the first region 110L accounts for the left half of the light receiving face 110a, while the second region 110R accounts for the right half. When imaging is performed with the interchangeable lens unit 200, a left-eye optical image is formed in the first region 110L, and a right-eye optical image is formed in the second region 110R.

The CMOS image sensor 110 is an example of an imaging element that converts an optical image of a subject into an electrical image signal. “Imaging element” is a concept that encompasses the CMOS image sensor 110 as well as a CCD image sensor or other such opto-electric conversion element.

(2) Camera Monitor 120

The camera monitor 120 is a liquid crystal display, for example, and displays display-use image data as an image. This display-use image data is image data that has undergone image processing, data for displaying the imaging conditions, operating menu, and so forth of the digital camera 1, or the like, and is produced by the camera controller 140. The camera monitor 120 is capable of selectively displaying both moving and still pictures. Furthermore, the camera monitor 120 can also give a three-dimensional display of a stereo image. More specifically, a display controller 125 gives a three-dimensional display of a stereo image on the camera monitor 120. The image displayed three-dimensionally on the camera monitor 120 can be seen in 3-D by using special glasses, for example. As shown in FIG. 5, in this embodiment the camera monitor 120 is disposed on the rear face of the camera body 100, but the camera monitor 120 may be disposed anywhere on the camera body 100.

The camera monitor 120 is an example of a display section provided to the camera body 100. The display section could also be an organic electroluminescence component, an inorganic electroluminescence component, a plasma display panel, or another such device that allows images to be displayed.

(3) Electronic Viewfinder 180

The electronic viewfinder 180 displays as an image the display-use image data produced by the camera controller 140. The EVF 180 is capable of selectively displaying both moving and still pictures. The EVF 180 and the camera monitor 120 may both display the same content, or may display different content. They are both controlled by the display controller 125.

(4) Display Controller 125

The display controller 125 (an example of a display determination section) controls the display state of the camera monitor 120 and the electronic viewfinder 180. More specifically, the display controller 125 can give a two-dimensional display of an ordinary image on the camera monitor 120 and the electronic viewfinder 180, or can give a three-dimensional display of a stereo image on the camera monitor 120.

Also, the display controller 125 determines whether or not to give a three-dimensional display of a stereo image on the basis of the detection result of an evaluation information determination section 158 (discussed below). For example, if an evaluation flag (discussed below) indicates “low,” then the display controller 125 displays a warning message on the camera monitor 120.

(5) Manipulation Unit 130

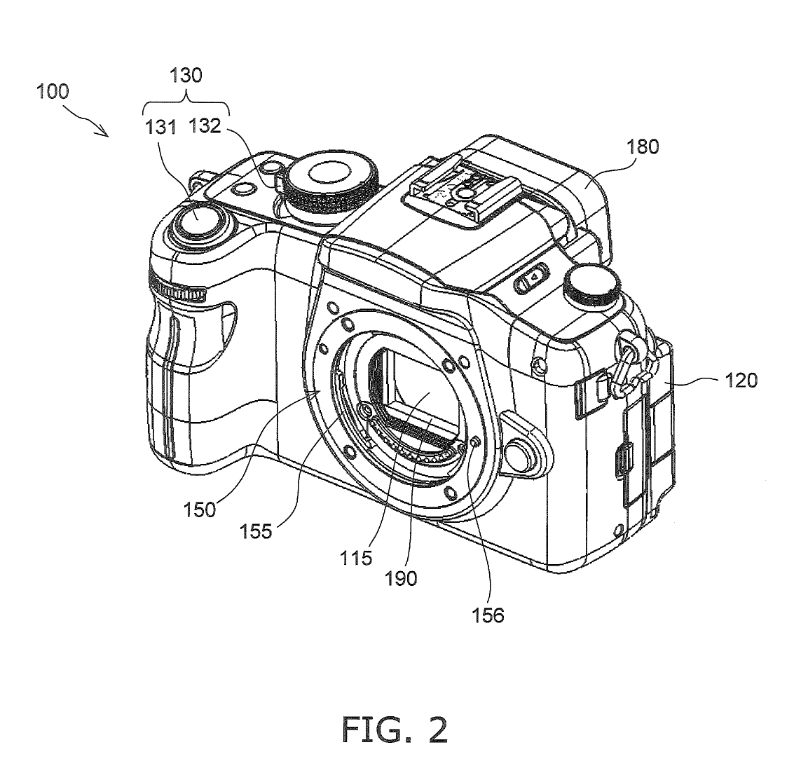

As shown in FIGS. 1 and 2, the manipulation unit 130 has a release button 131 and a power switch 132. The release button 131 is used for shutter operation by the user. The power switch 132 is a rotary lever switch provided to the top face of the camera body 100. The manipulation unit 130 encompasses a button, lever, dial, touch panel, or the like, so long as it can be operated by the user.

(6) Card Slot 170

The card slot 170 allows the memory card 171 to be inserted. The card slot 170 controls the memory card 171 on the basis of control from the camera controller 140. More specifically, the card slot 170 stores image data on the memory card 171 and outputs image data from the memory card 171. For example, the card slot 170 stores moving picture data on the memory card 171 and outputs moving picture data from the memory card 171.

The memory card 171 is able to store the image data produced by the camera controller 140 in image processing. For instance, the memory card 171 can store uncompressed raw image files, compressed JPEG image files, or the like. Furthermore, the memory card 171 can store stereo image files in multi-picture format (MPF).

Also, image data that have been internally stored ahead of time can be outputted from the memory card 171 via the card slot 170. The image data or image files outputted from the memory card 171 are subjected to image processing by the camera controller 140. For example, the camera controller 140 produces display-use image data by subjecting the image data or image files acquired from the memory card 171 to expansion or the like.

The memory card 171 is further able to store moving picture data produced by the camera controller 140 in image processing. For instance, the memory card 171 can store moving picture files compressed according to H.264/AVC, which is a moving picture compression standard. Stereo moving picture files can also be stored. The memory card 171 can also output, via the card slot 170, moving picture data or moving picture files internally stored ahead of time. The moving picture data or moving picture files outputted from the memory card 171 are subjected to image processing by the camera controller 140. For example, the camera controller 140 subjects the moving picture data or moving picture files acquired from the memory card 171 to expansion processing and produces display-use moving picture data.

(7) Shutter Unit 190

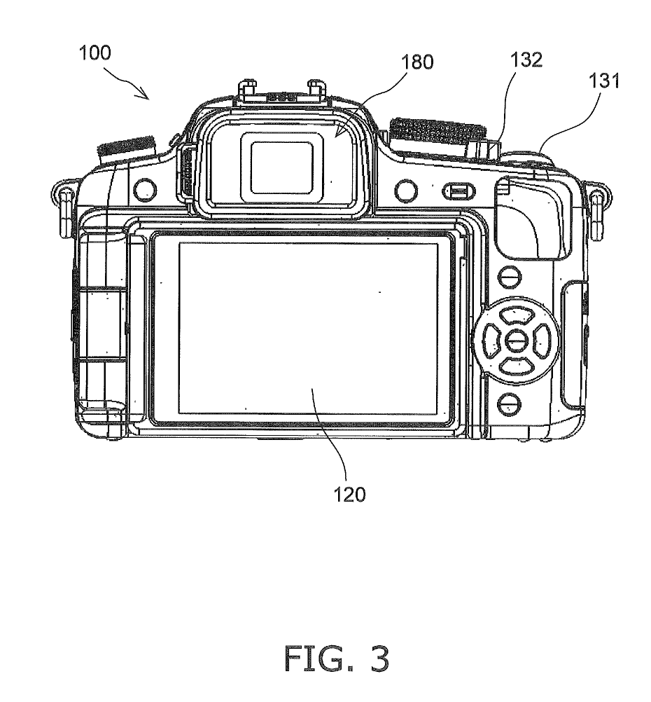

The shutter unit 190 is what is known as a focal plane shutter, and is disposed between the body mount 150 and the CMOS image sensor 110, as shown in FIG. 3. The charging of the shutter unit 190 is performed by a shutter motor 199. The shutter motor 199 is a stepping motor, for example, and is controlled by the camera controller 140.

(8) Body Mount 150

The body mount 150 allows the interchangeable lens unit 200 to be mounted, and holds the interchangeable lens unit 200 in a state in which the interchangeable lens unit 200 is mounted. The body mount 150 can be mechanically and electrically connected to the lens mount 250 of the interchangeable lens unit 200. Data and/or control signals can be sent and received between the camera body 100 and the interchangeable lens unit 200 via the body mount 150 and the lens mount 250. More specifically, the body mount 150 and the lens mount 250 send and receive data and/or control signals between the camera controller 140 and the lens controller 240.

(9) Camera Controller 140

The camera controller 140 controls the entire camera body 100. The camera controller 140 is electrically connected to the manipulation unit 130. Manipulation signals from the manipulation unit 130 are inputted to the camera controller 140. The camera controller 140 uses the DRAM 141 as a working memory during control operation or image processing operation.

Also, the camera controller 140 sends signals for controlling the interchangeable lens unit 200 through the body mount 150 and the lens mount 250 to the lens controller 240, and indirectly controls the various components of the interchangeable lens unit 200. The camera controller 140 also receives various kinds of signal from the lens controller 240 via the body mount 150 and the lens mount 250.

The camera controller 140 has a CPU (central processing unit) 140a, a ROM (read only memory) 140b, and a RAM (random access memory) 140c, and can perform various functions by reading the programs stored in the ROM 140b into the CPU 140a.

Details of Camera Controller 140

The functions of the camera controller 140 will now be described in detail.

First, the camera controller 140 detects whether or not the interchangeable lens unit 200 is mounted to the camera body 100 (more precisely, to the body mount 150). More specifically, as shown in FIG. 6, the camera controller 140 has a lens detector 146. When the interchangeable lens unit 200 is mounted to the camera body 100, signals are exchanged between the camera controller 140 and the lens controller 240. The lens detector 146 determines whether or not the interchangeable lens unit 200 has been mounted on the basis of this exchange of signals.

Also, the camera controller 140 has various other functions, such as the function of determining whether or not the interchangeable lens unit mounted to the body mount 150 is compatible with three-dimensional imaging, and the function of acquiring information related to three-dimensional imaging from the interchangeable lens unit. More specifically, the camera controller 140 has an identification information acquisition section 142, a characteristic information acquisition section 143, a camera-side determination section 144, a state information acquisition section 145, an extraction position correction section 139, a region decision section 149, a metadata production section 147, an image file production section 148, a deviation amount calculator 155, an evaluation information production section 156, and an evaluation information determination section 158. These functions are realized when the CPU 140a (an example of a computer) reads programs recorded to the ROM 140b.

The identification information acquisition section 142 acquires the lens identification information F1, which indicates whether or not the interchangeable lens unit 200 is compatible with three-dimensional imaging, from the interchangeable lens unit 200 mounted to the body mount 150. As shown in FIG. 7A, the lens identification information F1 is information indicating whether or not the interchangeable lens unit mounted to the body mount 150 is compatible with three-dimensional imaging, and is stored in the flash memory 242 of the lens controller 240, for example. The lens identification information F1 is a three-dimensional imaging determination flag stored at a specific address in the flash memory 242. The identification information acquisition section 142 temporarily stores the acquired lens identification information F1 in the DRAM 141, for example.

The camera-side determination section 144 determines whether or not the interchangeable lens unit 200 mounted to the body mount 150 is compatible with three-dimensional imaging on the basis of the lens identification information F1 acquired by the identification information acquisition section 142. If it is determined by the camera-side determination section 144 that the interchangeable lens unit 200 mounted to the body mount 150 is compatible with three-dimensional imaging, the camera controller 140 permits the execution of a three-dimensional imaging mode. On the other hand, if it is determined by the camera-side determination section 144 that the interchangeable lens unit 200 mounted to the body mount 150 is not compatible with three-dimensional imaging, the camera controller 140 does not execute the three-dimensional imaging mode. In this case the camera controller 140 permits the execution of a two-dimensional imaging mode.

The characteristic information acquisition section 143 (an example of a correction information acquisition section) acquires from the interchangeable lens unit 200 the lens characteristic information F2, which indicates the characteristics of the optical system installed in the interchangeable lens unit 200. More specifically, the characteristic information acquisition section 143 acquires the above-mentioned lens characteristic information F2 from the interchangeable lens unit 200 when it has been determined by the camera-side determination section 144 that the interchangeable lens unit 200 is compatible with three-dimensional imaging. The characteristic information acquisition section 143 temporarily stores the acquired lens characteristic information F2 in the DRAM 141, for example.

The state information acquisition section 145 acquires the lens state information F3 (imaging possibility flag) produced by the state information production section 243. This lens state information F3 is used in determining whether or not the interchangeable lens unit 200 is in a state that allows imaging. The state information acquisition section 145 temporarily stores the acquired lens state information F3 in the DRAM 141, for example.

The extraction position correction section 139 corrects the center position of the extraction regions AL0 and AR0 on the basis of the extraction position correction amount L11. In the initial state, the center of the extraction region AL0 is set to the center ICL of the image circle IL, and the center of the extraction region AR0 is set to the center ICR of the image circle IR. The extraction position correction section 139 horizontally moves the extraction center by the extraction position correction amount L11 from the centers ICL and ICR, and sets new extraction centers ACL2 and ACR2 (an example of recommended image extraction positions) as a reference for extracting the left-eye image data and right-eye image data. The extraction regions using the extraction centers ACL2 and ACR2 as a reference become the extraction regions AL2 and AR2 shown in FIG. 9. Thus, the extraction regions can be set according to the characteristics of the interchangeable lens unit, and a better stereo image can be obtained by correcting the positions of the extraction centers using the extraction position correction amount L11.

In this embodiment, since the interchangeable lens unit 200 has a zoom function, if the focal length changes due to zooming, the recommended convergence point distance L10 changes, and this is also accompanied by a change in the extraction position correction amount L11. Therefore, the extraction position correction amount L11 may be recalculated by computation according to the zoom position.

More specifically, the lens controller 240 can ascertain the zoom position on the basis of the detection result of a zoom position sensor (not shown). The lens controller 240 sends zoom position information to the camera controller 140 at a specific period. The zoom position information is temporarily stored in the DRAM 141.

Meanwhile, the extraction position correction section 139 calculates the extraction position correction amount suited to the focal length on the basis of the zoom position information, the recommended convergence point distance L10, and the extraction position correction amount L11. Here, information indicating the relation between the zoom position information, the recommended convergence point distance L10, and the extraction position correction amount L11 (such as a computational formula or a table) may be stored in the camera body 100, or may be stored in the flash memory 242 of the interchangeable lens unit 200. The extraction position correction amount is updated at a specific period. The updated extraction position correction amount is stored at a specific address of the DRAM 141. In this case, the extraction position correction section 139 corrects the center positions of the extraction regions AL0 and AR0 on the basis of the newly calculated extraction position correction amount, just as with the extraction position correction amount L11.

The region decision section 149 decides the size and position of the extraction regions AL3 and AR3 used in extracting the left-eye image data and the right-eye image data with an image extractor 16. More specifically, the region decision section 149 decides the size and position of the extraction regions AL3 and AR3 of the left-eye image data and the right-eye image data on the basis of the extraction centers ACL2 and ACR2 calculated by the extraction position correction section 139, the radius r of the image circles IL and IR, and the left-eye deviation amount DL and right-eye deviation amount DR included in the lens characteristic information F2. Here, the region decision section 149 uses the extraction centers ACL2 and ACR2, left-eye deviation amounts DL (DLx and DLy), and right-eye deviation amounts DR (DRx and DRy) to find extraction centers ACL3 and ACR3, and temporarily stores the extraction centers ACL3 and ACR3 in the RAM 140c.

The region decision section 149 decides the starting point for extraction processing of the image data so that the left-eye image data and the right-eye image data can be properly extracted, on the basis of a 180-degree rotation flag, which indicates whether or not the left-eye optical image and right-eye optical image have rotated, a layout change flag, which indicates the left and right positions of the left-eye optical image and right-eye optical image, and a mirror inversion flag, which indicates whether or not the left-eye optical image and right-eye optical image have undergone mirror inversion.

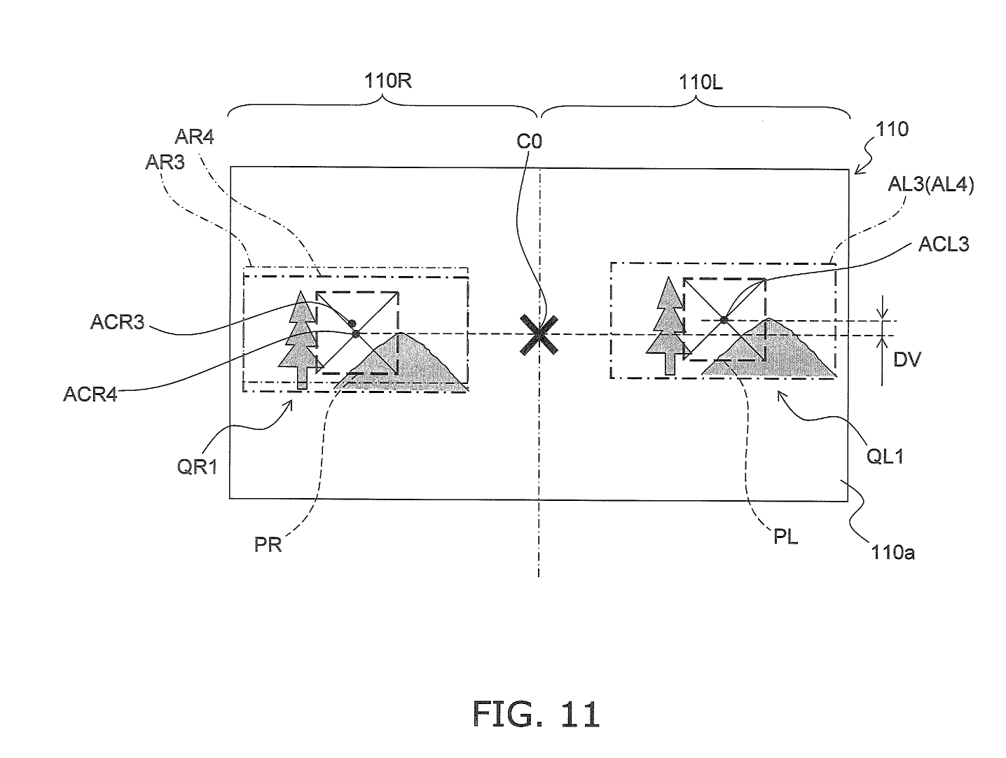

In this embodiment, the extraction regions AL3 and AR3 are merely detection regions for pattern matching processing, and extraction regions AL4 and AR4 (see FIG. 11), which are eventually used in cropping out left- and right-eye image data, are decided on the basis of a vertical relative deviation amount DV calculated using pattern matching processing. The method for deciding the extraction regions AL4 and AR4 will be discussed below.

The deviation amount calculator 155 (an example of a deviation amount calculator) calculates the relative deviation amount of the left-eye image data and right-eye image data. More specifically, the deviation amount calculator 155 uses pattern matching processing to calculate the relative deviation amount (the vertical relative deviation amount DV) in the vertical direction (up and down direction) for the left- and right-eye image data.

The term “vertical relative deviation amount DV” as used herein is the amount of deviation in the left- and right-eye image data in the up and down direction caused by individual differences between interchangeable lens units 200 (such as individual differences between interchangeable lens units or attachment error in mounting the interchangeable lens unit to the camera body). Therefore, the vertical relative deviation amount DV calculated by the deviation amount calculator 155 includes the left-eye deviation amount DL and right-eye deviation amount DR in the vertical direction.

The deviation amount calculator 155 calculates the concordance (an example of reference information) between first image data, which corresponds to part of the left-eye image data, and second image data, which corresponds to part of the right-eye image data, using pattern matching processing. An example of the input image data here is basic image data including left-eye image data and right-eye image data.

For example, the deviation amount calculator 155 performs pattern matching processing on the basic image data produced by a signal processor 15 (discussed below). In this case, as shown in FIG. 11, the deviation amount calculator 155 searches the extraction region AR3 for the second image data PR with the highest concordance with the first image data PL on the basis of the first image data PL in the extraction region AL3. The size of the first image data PL is decided ahead of time, but the position of the first image data PL is decided by the deviation amount calculator 155 so that the center of the first image data PL will coincide with the extraction center ACL3 decided by the region decision section 149. In finding the second image data PR by pattern matching processing, the deviation amount calculator 155 calculates the concordance with the first image data PL for a plurality of regions of the same size as the first image data. Furthermore, the deviation amount calculator 155 uses the image data in the region with the highest concordance as the second image data PR, and sets this highest concordance to be the reference concordance C.

The term “concordance” here is a numerical value indicating how well two sets of image data coincide visually, and can be calculated during pattern matching processing. The numerical value indicating concordance is the reciprocal of a value obtained by totaling for all pixels the square of the difference in brightness of pixels corresponding to two sets of image data, or the reciprocal of a value obtained by totaling for all pixels the absolute value of the difference in brightness for pixels corresponding to two sets of image data. The greater is this numerical value, the better is the concordance between the two images. Furthermore, the numerical value indicating concordance need not be a reciprocal, and may instead be, for example, a value obtained by totaling for all pixels the square of the difference in brightness of pixels corresponding to two sets of image data, or a value obtained by totaling for all pixels the absolute value of the difference in brightness for pixels corresponding to two sets of image data.

“Concordance” is a concept that is the flip side to “discrepancy,” and if the “discrepancy” is calculated, that means that the “concordance” has been calculated. Therefore, in this embodiment, a configuration is described in which the deviation amount calculator 155 calculates the concordance, but a configuration is also possible in which the deviation amount calculator 155 calculates not the concordance, but the discrepancy. This “discrepancy” is a numerical value indicating how much two images differ (more precisely, how much a part of two images differ). The reference concordance C calculated by the deviation amount calculator 155 is temporarily stored in the DRAM 141, or in the RAM 140c of the camera controller 140.

The vertical relative deviation amount DV calculated by the deviation amount calculator 155 is temporarily stored in the RAM 140c of the camera controller 140 or in the DRAM 141, for example. The vertical relative deviation amount DV is used to correct the position of the extraction regions. More specifically, as shown in FIG. 11, the region decision section 149 calculates the center ACR4 of the extraction region AR4 for the right-eye image data on the basis of the vertical relative deviation amount DV and the coordinate in the vertical direction of the extraction center ACL3, and decides the extraction region AR4 using the center ACR4 as the center. The size of the extraction region AR4 is the same as that of the extraction region AR3. On the other hand, the extraction region AR3 is used as-is for the extraction region AL4 for the left-eye image data.

Thus, the final extraction regions AL4 and AR4 are decided on the basis of the vertical relative deviation amount DV calculated by the deviation amount calculator 155, so the reference concordance C calculated by the deviation amount calculator 155 can be considered to be equivalent to the concordance of the left- and right-eye image data cropped out on the basis of the extraction regions AL4 and AR4.

The evaluation information production section 156 (an example of an evaluation information production section) produces evaluation information related to the suitability of three-dimensional display on the basis of the concordance calculated by the deviation amount calculator 155. More specifically, the evaluation information production section 156 has a comparator 156a (an example of a comparator) that compares the concordance with a preset reference value, and a production section 156b (an example of a production section) that produces evaluation information on the basis of the comparison result of the comparator 156a. In this embodiment, three types of evaluation flags (“high,” “medium,” and “low”) are preset as the evaluation information, and two types of reference value are predetermined accordingly. If an evaluation flag is “high,” it indicates that with a stereo image produced from the left- and right-eye image data being evaluated, there is high concordance between the left- and right-eye image data cropped out from the extraction regions AL4 and AR4 that were ultimately decided on, and that an extremely good 3-D view can be anticipated if this stereo image is used. If an evaluation flag is “medium,” it indicates that with a stereo image produced from the left- and right-eye image data being evaluated, the concordance between the left- and right-eye image data cropped out from the extraction regions AL4 and AR4 that were ultimately decided on is within the acceptable range, and that there will be no particular problems with the 3-D view if this stereo image is used. If an evaluation flag is “low,” it indicates that with a stereo image produced from the left- and right-eye image data being evaluated, the concordance between the left- and right-eye image data cropped out from the extraction regions AL4 and AR4 that were ultimately decided on is so low that the 3-D view will not be very good if this stereo image is used.

Meanwhile, a first reference value V1 between evaluation flags of “high” and “medium” and a second reference value V2 between evaluation flags of “medium” and “low” are set as reference values in order to carry out this three-level evaluation. The first reference value V1 and the second reference value V2 are stored ahead of time in the ROM 140b, for example. If we let C be the concordance, then the concordance is rated according to the following conditional formulas.

evaluation flag “high”: V1≦C (1)

evaluation flag “medium”: V2≦C<V1 (2)

evaluation flag “low”: C<V2 (3)

More precisely, the comparator 156a compares the reference concordance C with the first reference value V1 and the second reference value V2, and determines whether the reference concordance C satisfies all the conditional formulas. If the numerical value indicating concordance is not a reciprocal, then the magnitude relation between the reference concordance C and the first reference value V1 and second reference value V2 in the above-mentioned conditional formulas 1 to 3 is reversed.

Also, the production section 156b selects an evaluation flag of either “high,” “medium,” or “low” on the basis of the comparison result of the comparator 156a. The selected evaluation flag is temporarily stored in the DRAM 141 or the RAM 140c.

The metadata production section 147 (an example of an information adder) produces metadata with set stereo base and angle of convergence. Here, the metadata production section 147 puts the evaluation flag produced by the evaluation information production section 156 into a specific region within the metadata. The stereo base and convergence angle are used in displaying a stereo image. Also, the evaluation flag is used in the three-dimensional display of a stereo image.

The image file production section 148 (an example of an information adder) produces MPF stereo image files by combining left- and right-eye image data compressed by an image compressor 17 (discussed below). The image files thus produced are sent to the card slot 170 and stored in the memory card 171, for example. Since the image file production section 148 adds metadata including an evaluation flag to the left- and right-eye image data, it could also be said that the image file production section 148 adds an evaluation flag to the left- and right-eye image data.

The evaluation information determination section 158 (an example of an evaluation information determination section) detects an evaluation flag from an inputted stereo image. More specifically, the evaluation information determination section 158 determines whether or not an evaluation flag has been added to a stereo image. If an evaluation flag has been added to the stereo image, the evaluation information determination section 158 determines the content of the evaluation flag. For example, the evaluation information determination section 158 can determine whether the evaluation flag indicates “high,” “medium,” or “low.”

In this embodiment, the evaluation flag is put into a specific region within the metadata, but the evaluation flag may be put into another region, or may be a separate file that is associated with a stereo image. Even in a case in which the evaluation flag is a separate file that is associated with a stereo image, it can be said that the evaluation flag has been added to the stereo image.

(10) Image Processor 10

The image processor 10 has the signal processor 15, the image extractor 16, a correction processor 18, and the image compressor 17.

The signal processor 15 digitizes the image signal produced by the CMOS image sensor 110, and produces basic image data for the optical image formed on the CMOS image sensor 110. More specifically, the signal processor 15 converts the image signal outputted from the CMOS image sensor 110 into a digital signal, and subjects this digital signal to digital signal processing such as noise elimination or contour enhancement. The image data produced by the signal processor 15 is temporarily stored as raw data in the DRAM 141. Here, image data produced by the signal processor 15 is called basic image data.

The image extractor 16 extracts left-eye image data and right-eye image data from the basic image data produced by the signal processor 15. The left-eye image data corresponds to the part of the left-eye optical image QL1 formed by the left-eye optical system OL. The right-eye image data corresponds to the part of the right-eye optical image QR1 formed by the right-eye optical system OR. The image extractor 16 extracts left-eye image data and right-eye image data from the basic image data held in the DRAM 141, on the basis of the extraction regions AL3 and AR3 decided by the region decision section 149. The left-eye image data and right-eye image data extracted by the image extractor 16 are temporarily stored in the DRAM 141.

The correction processor 18 performs distortion correction, shading correction, and other such correction processing on the extracted left-eye image data and right-eye image data. After this correction processing, the left-eye image data and right-eye image data are temporarily stored in the DRAM 141.

The image compressor 17 performs compression processing on the corrected left- and right-eye image data stored in the DRAM 141, on the basis of a command from the camera controller 140. This compression processing reduces the image data to a smaller size than that of the original data. An example of the method for compressing the image data is the JPEG (Joint Photographic Experts Group) method in which compression is performed on the image data for each frame. The compressed left-eye image data and right-eye image data are temporarily stored in the DRAM 141.

Operation of Digital Camera

(1) When Power is On

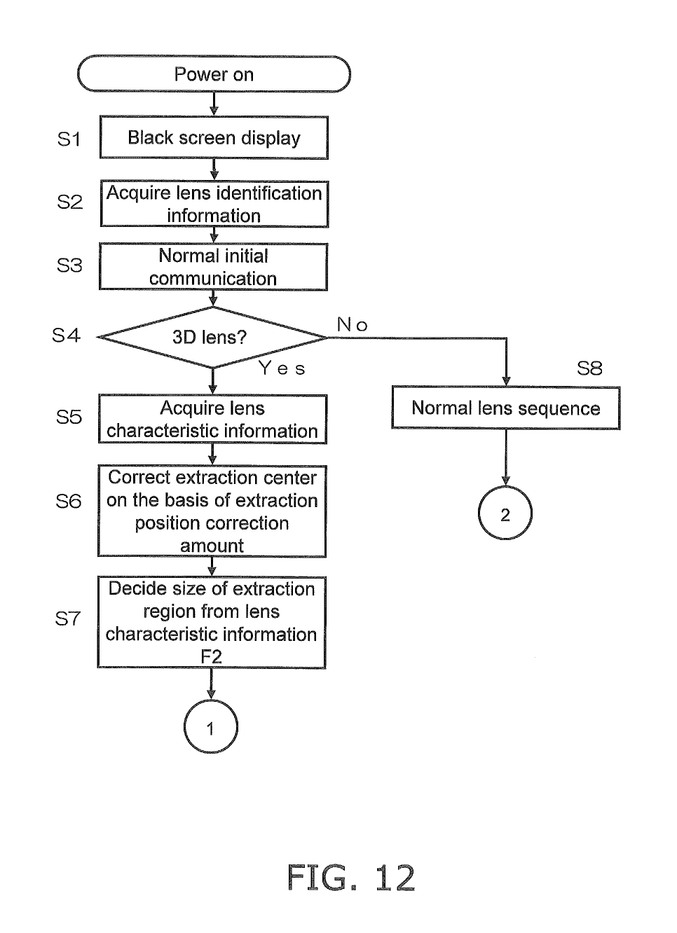

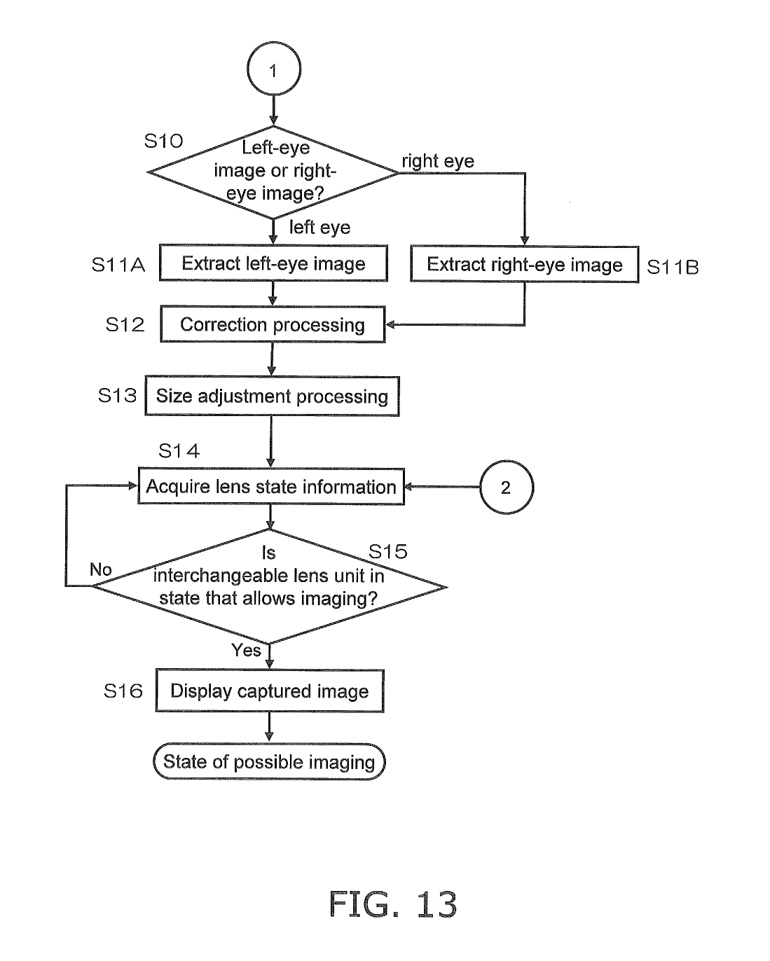

Determination of whether or not the interchangeable lens unit 200 is compatible with three-dimensional imaging is possible either when the interchangeable lens unit 200 is mounted to the camera body 100 in a state in which the power to the camera body 100 is on, or when the power is turned on to the camera body 100 in a state in which the interchangeable lens unit 200 has been mounted to the camera body 100. Here, the latter case will be used as an example to describe the operation of the digital camera 1 through reference to FIGS. 8A, 8B, 12, and 13. Of course, the same operation may also be performed in the former case.

When the power is turned on, a black screen is displayed on the camera monitor 120 under control of the display controller 125, and the blackout state of the camera monitor 120 is maintained (step S1). Next, the identification information acquisition section 142 of the camera controller 140 acquires the lens identification information F1 from the interchangeable lens unit 200 (step S2). More specifically, as shown in FIGS. 8A and 8B, when the mounting of the interchangeable lens unit 200 is detected by the lens detector 146 of the camera controller 140, the camera controller 140 sends a model confirmation command to the lens controller 240. This model confirmation command is a command that requests the lens controller 240 to send the status of a three-dimensional imaging determination flag for the lens identification information F1. As shown in FIG. 8B, since the interchangeable lens unit 200 is compatible with three-dimensional imaging, upon receiving the model confirmation command, the lens controller 240 sends the lens identification information F1 (three-dimensional imaging determination flag) to the camera body 100. The identification information acquisition section 142 temporarily stores the status of this three-dimensional imaging determination flag in the DRAM 141.

Next, ordinary initial communication is executed between the camera body 100 and the interchangeable lens unit 200 (step S3). This ordinary initial communication is also performed between the camera body and an interchangeable lens unit that is not compatible with three-dimensional imaging. For example, information related to the specifications of the interchangeable lens unit 200 (its focal length, F stop value, etc.) is sent from the interchangeable lens unit 200 to the camera body 100.

After this ordinary initial communication, the camera-side determination section 144 determines whether or not the interchangeable lens unit 200 mounted to the body mount 150 is compatible with three-dimensional imaging (step S4). More specifically, the camera-side determination section 144 determines whether or not the mounted interchangeable lens unit 200 is compatible with three-dimensional imaging on the basis of the lens identification information F1 (three-dimensional imaging determination flag) acquired by the identification information acquisition section 142.

If the mounted interchangeable lens unit is not compatible with three-dimensional imaging, the normal sequence corresponding to two-dimensional imaging is executed, and the processing moves to step S14 (step S8). If an interchangeable lens unit that is compatible with three-dimensional imaging, such as the interchangeable lens unit 200, is mounted, then the lens characteristic information F2 is acquired by the characteristic information acquisition section 143 from the interchangeable lens unit 200 (step S5). More specifically, as shown in FIG. 8B, a characteristic information transmission command is sent from the characteristic information acquisition section 143 to the lens controller 240. This characteristic information transmission command is a command that requests the transmission of lens characteristic information F2. When it receives this command, the camera controller 140 sends the lens characteristic information F2 to the camera controller 140. The characteristic information acquisition section 143 stores the lens characteristic information F2 in the DRAM 141, for example.

After acquisition of the lens characteristic information F2, the positions of the extraction centers of the extraction regions AL0 and AR0 are corrected by the extraction position correction section 139 on the basis of the lens characteristic information F2 (step S6). More specifically, the extraction position correction section 139 corrects the center positions of the extraction regions AL0 and AR0 on the basis of the extraction position correction amount L11 (or an extraction position correction amount newly calculated from the extraction position correction amount L11). The extraction centers are moved horizontally by the extraction position correction amount L11 (or an extraction position correction amount newly calculated from the extraction position correction amount L11) from the centers ICL and ICR, and the extraction centers ACL2 and ACR2 are newly set as a reference for extracting the left-eye image data and right-eye image data by the extraction position correction section 139.

Furthermore, the extraction method and the size of the extraction regions AL3 and AR3 are decided by the region decision section 149 on the basis of the lens characteristic information F2 (step S7). For instance, as discussed above, the region decision section 149 decides the sizes of the extraction regions AL3 and AR3 on the basis of the optical axis position, the effective imaging area (radius r), the extraction centers ACL2 and ACR2, the left-eye deviation amount DL, the right-eye deviation amount DR, and the size of the CMOS image sensor 110. For example, the sizes of the extraction regions AL3 and AR3 are decided by the region decision section 149 on the basis of the above-mentioned information so that the extraction regions AL3 and AR3 will fit in the horizontal imaging-use extractable ranges AL11 and AR11. As discussed above, in this embodiment, the extraction regions AL3 and AR3 are merely detection regions for pattern matching processing, and the positions of the extraction regions eventually used in cropping out the left- and right-eye image data are decided on the basis of the vertical relative deviation amount DV calculated using pattern matching processing.

A limiting convergence point distance L12 and an extraction position limiting correction amount L13 may be used when the region decision section 149 decides the extraction regions AL3 and AR3.

Also, the extraction method, that is, which of the extraction regions AL3 and AR3 will be used for the right eye, whether the image will be rotated, and whether the image will be mirror inverted, may be decided by the region decision section 149.

Furthermore, the image used for live-view display is selected from among the left- and right-eye image data (step S10). For example, the user may select from among the left- and right-eye image data, or the one pre-decided by the camera controller 140 may be set for display use. The selected image data is set as the display-use image, and extracted by the image extractor 16 (step S11A or 11B).

Then, the extracted image data is subjected by the correction processor 18 to distortion correction, shading correction, or other such correction processing (step S12).

Furthermore, size adjustment processing is performed on the corrected image data by the display controller 125, and display-use image data is produced (step S13). This correction-use image data is temporarily stored in the DRAM 141.

After this, the state information acquisition section 145 confirms whether or not the interchangeable lens unit is in a state that allows imaging (step S14). More specifically, with the interchangeable lens unit 200, when the lens-side determination section 244 receives the above-mentioned characteristic information transmission command, the lens-side determination section 244 determines that the camera body 100 is compatible with three-dimensional imaging (see FIG. 8B). Meanwhile, the lens-side determination section 244 determines that the camera body is not compatible with three-dimensional imaging if no characteristic information transmission command has been sent from the camera body within a specific period of time (see FIG. 8A).

The state information production section 243 sets the status of an imaging possibility flag (an example of standby information) indicating whether or not the three-dimensional optical system G is in the proper imaging state, on the basis of the determination result of the lens-side determination section 244. The state information production section 243 sets the status of the imaging possibility flag to “possible” when the lens-side determination section 244 has determined that the camera body is compatible with three-dimensional imaging (FIG. 8B). On the other hand, the state information production section 243 sets the status of the imaging possibility flag to “impossible,” regardless of whether or not the initialization of the various components has been completed, when the lens-side determination section 244 has determined that the camera body is not compatible with three-dimensional imaging (see FIG. 8A). In step S14, if a command is sent that requests the transmission of status information about the imaging possibility flag from the state information acquisition section 145 to the lens controller 240, the state information production section 243 sends status information about the imaging possibility flag to the camera controller 140. The status information about the imaging possibility flag is sent to the camera controller 140. With the camera body 100, the state information acquisition section 145 temporarily stores the status information about the imaging possibility flag sent from the lens controller 240 at a specific address in the DRAM 141.

Further, the state information acquisition section 145 determines whether or not the interchangeable lens unit 200 is in a state that allows imaging, on the basis of the stored imaging possibility flag (step S15). If the interchangeable lens unit 200 is not in a state that allows imaging, the processing of steps S14 and S15 is repeated for a specific length of time. On the other hand, if the interchangeable lens unit 200 is in a state that allows imaging, the display-use image data produced in step S13 is displayed as a visible image on the camera monitor 120 (step S16). From step S16 on, a left-eye image, a right-eye image, an image that is a combination of a left-eye image and a right-eye image, or a three-dimensional image using a left-eye image and a right-eye image is displayed in live view.

(2) Three-Dimensional Still Picture Imaging

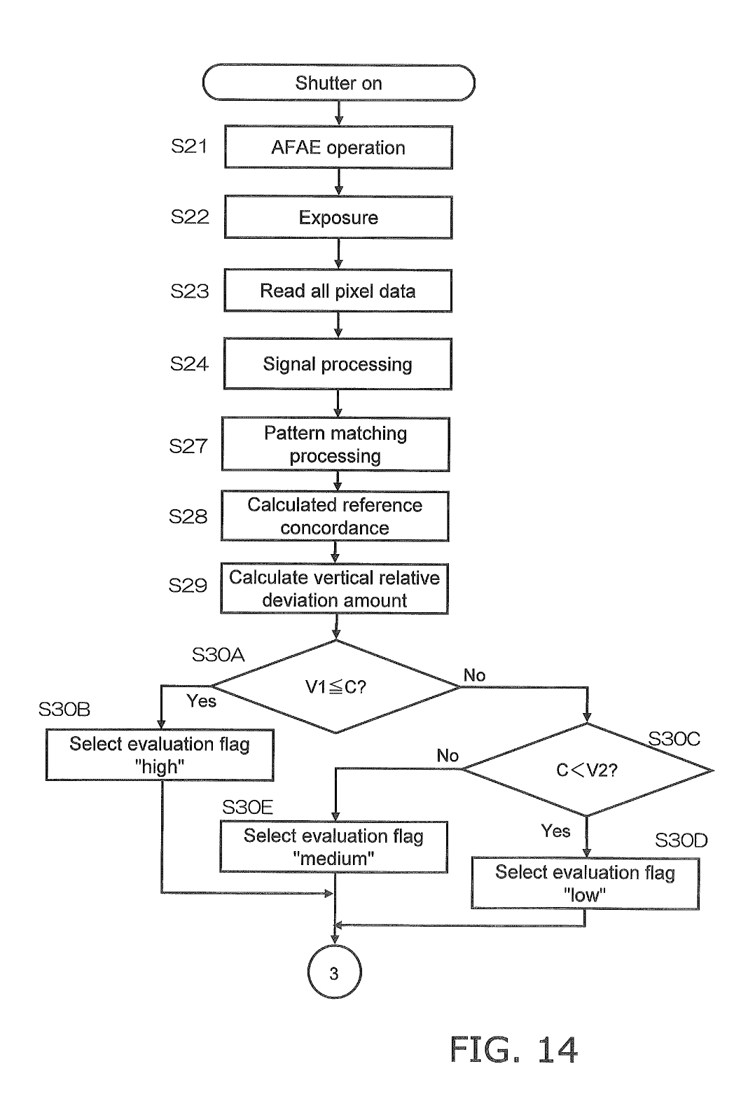

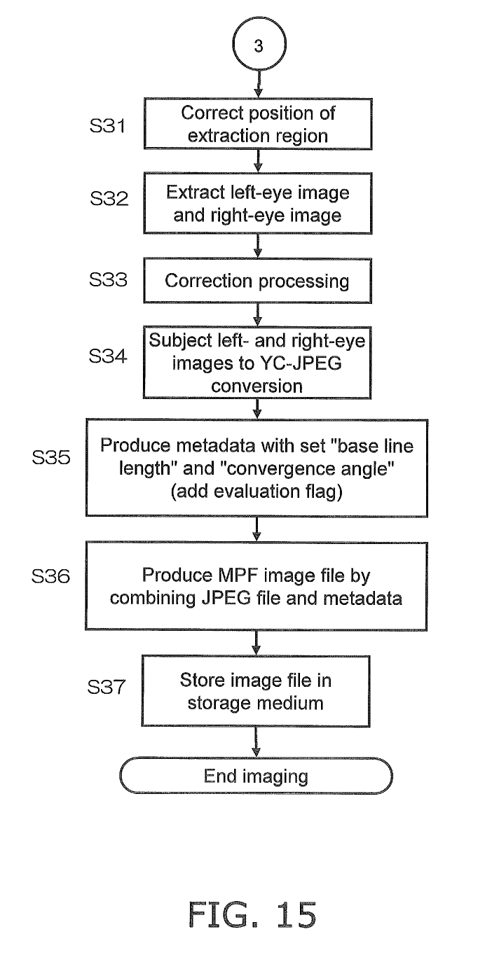

The operation in three-dimensional still picture imaging will now be described through reference to FIGS. 14 and 15.

When the user presses the release button 131, autofocusing (AF) and automatic exposure (AE) are executed, and then exposure is commenced (steps S21 and S22). An image signal from the CMOS image sensor 110 (data for all pixels) is taken in by the signal processor 15, and the image signal is subjected to AD conversion or other such signal processing by the signal processor 15 (steps S23 and S24). The basic image data produced by the signal processor 15 is temporarily stored in the DRAM 141.

Next, the deviation amount calculator 155 performs pattern matching processing on the extraction regions AL3 and AR3 of the basic image data (step S27). During or after the pattern matching processing, the deviation amount calculator 155 calculates the reference concordance C, which indicates how well the images from the two extraction regions coincide (step S28). More precisely, the deviation amount calculator 155 searches for the matching region that best coincides with the image of a specific reference region in the extraction region AR3 (the second image data PR shown in FIG. 11) on the basis of the image of a specific reference region in the extraction region AL3 (the first image data PL shown in FIG. 11), from among the basic image data produced by the signal processor 15. In finding the second image data PR by pattern matching processing, the deviation amount calculator 155 calculates the concordance with the first image data PL for a plurality of regions of the same size as the first image data. Furthermore, the image data in the region with the highest concordance is set by the deviation amount calculator 155 to the second image data PR, and this highest concordance is set by the deviation amount calculator 155 to the reference concordance C. The reference concordance C calculated by the deviation amount calculator 155 is temporarily stored in the DRAM 141 or in the RAM 140c of the camera controller 140.

The vertical relative deviation amount DV for the left- and right-eye image data (see FIG. 11) is calculated by the deviation amount calculator 155 during or after pattern matching processing (step S29). The vertical relative deviation amount DV calculated by the deviation amount calculator 155 is temporarily stored in the DRAM 141 or the RAM 140c of the camera controller 140, for example.

After pattern matching processing, evaluation information is produced by the evaluation information production section 156 on the basis of the reference concordance C calculated by the deviation amount calculator 155. More specifically, the reference concordance C is compared by the comparator 156a with the preset first reference value V1 and second reference value V2. Furthermore, one piece of evaluation information is selected by the production section 156b from among the evaluation information “high,” “medium,” and “low” on the basis of the comparison result of the comparator 156a. More specifically, the comparator 156a compares the reference concordance C with the first reference value V1, and if the reference concordance C satisfies Conditional Formula 1 (Yes in step S30A), “high” is selected as the evaluation information by the production section 156b (step S30B). On the other hand, if the reference concordance C does not satisfy Conditional Formula 1 (No in step S30A), the reference concordance C is compared by the comparator 156a with the second reference value V2 (step S30C). If the reference concordance C satisfies Conditional Formula 3 (Yes in step S30C), “low” is selected as the evaluation information by the production section 156b (step S30D). On the other hand, if the reference concordance C does not satisfy Conditional Formula 3 (No in step S30C), since the reference concordance C does satisfy the Conditional Formula 2, “medium” is selected as the evaluation information by the production section 156b (step S30E). The evaluation information selected by the production section 156b is temporarily stored in the DRAM 141 or the RAM 140c.

Next, the positions of the extraction regions are decided by the region decision section 149 on the basis of the vertical relative deviation amount DV calculated in step S29 (step S31). More specifically, as shown in FIG. 11, the region decision section 149 calculates the center ACR4 of the extraction region AR4 for right-eye image data on the basis of the vertical relative deviation amount DV and the coordinate in the vertical direction of the extraction center ACL3, and decides the extraction region AR4 using the center ACR4 as the center. Since the extraction center ACL3 is used as a reference for pattern matching processing, the extraction region AL3 is used as-is for the extraction region for the left-eye image data. Consequently, the vertical relative deviation amount in left- and right-eye image data in a stereo image can be further reduced.

Also, since the final extraction regions AL4 and AR4 are thus decided on the basis of the vertical relative deviation amount DV calculated by the deviation amount calculator 155, the reference concordance C calculated by the deviation amount calculator 155 can be said to be equivalent to the concordance of left- and right-eye image data cropped out on the basis of the extraction regions AL4 and AR4.

Furthermore, the left-eye image data and right-eye image data are extracted by the image extractor 16 from the basic image data on the basis of the extraction regions AL4 and AR4 decided in step S31 (step S32). The correction processor 18 subjects the extracted left-eye image data and right-eye image data to correction processing (step S33).

The image compressor 17 performs JPEG compression or other such compression processing on the left-eye image data and right-eye image data (step S34).

After compression, the metadata production section 147 of the camera controller 140 produces metadata setting the stereo base and the convergence angle (step S35). Here, the evaluation information produced by the evaluation information production section 156 is put into a specific region of the metadata as a flag by the metadata production section 147.

After metadata production, the compressed left- and right-eye image data are combined with the metadata, and MPF image files are produced by the image file production section 148 (step S36). The produced image files are sent to the card slot 170 and stored in the memory card 171, for example (step S37). If these image files are displayed three-dimensionally using the stereo base and the convergence angle, the displayed image can be seen in 3-D view using special glasses or the like.

(3) Three-Dimensional Display

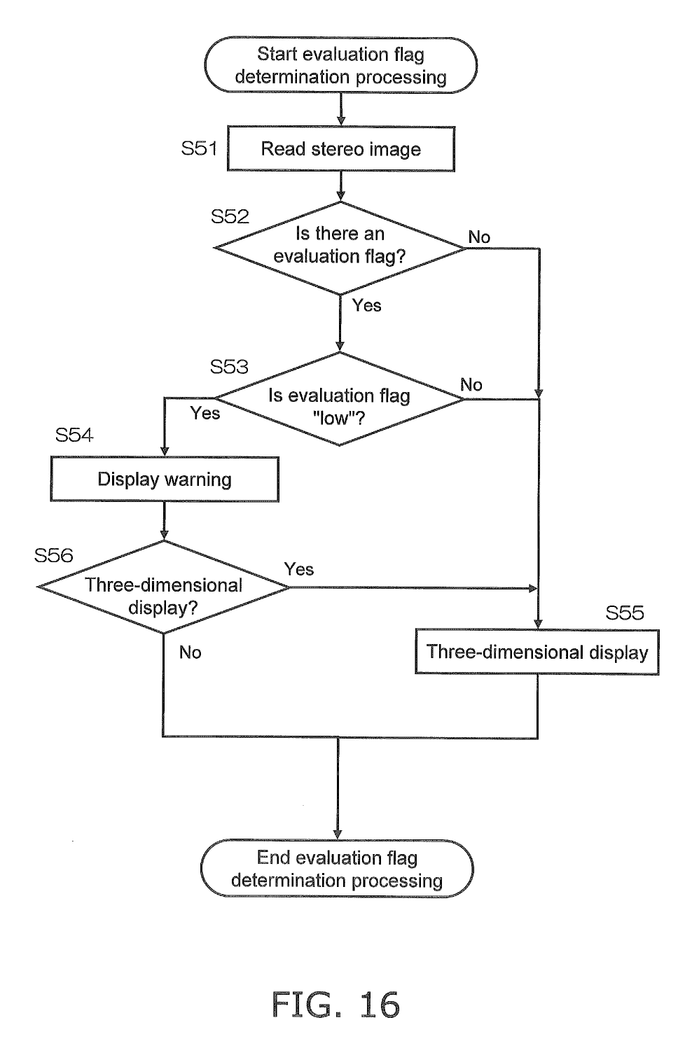

The evaluation flag determination processing during three-dimensional display will be described through reference to FIG. 16.

As shown in FIG. 16, the digital camera 1 has a three-dimensional display mode. In three-dimensional display mode, a stereo image is three-dimensionally displayed on the camera monitor 120. The three-dimensionally displayed stereo image can be seen in 3-D view by wearing special glasses or the like.

In three-dimensional display mode, stereo images stored in the memory card 171 are displayed as thumbnails on the camera monitor 120. Here, predetermined thumbnails from among the left- and right-eye image data are displayed on the camera monitor 120 as representative images. When the user manipulates the manipulation unit 130 to select the stereo image to be displayed three-dimensionally, the selected stereo image data is read to the DRAM 141 (step S51).

The evaluation information determination section 158 confirms whether or not evaluation information has been added as a flag to a specific region of the stereo image data (step S52). If there is no evaluation flag in the specific region, the selected stereo image is directly displayed three-dimensionally (step S55).

On the other hand, if there is an evaluation flag in the specific region, the evaluation information determination section 158 determines the content of the evaluation flag (step S53). More specifically, the evaluation information determination section 158 determines whether or not the evaluation flag indicates “low.” If the evaluation flag does not indicate “low,” then there is no problem with the selected stereo image being directly displayed three-dimensionally, so the selected stereo image is three-dimensionally displayed on the camera monitor 120 (step S55).

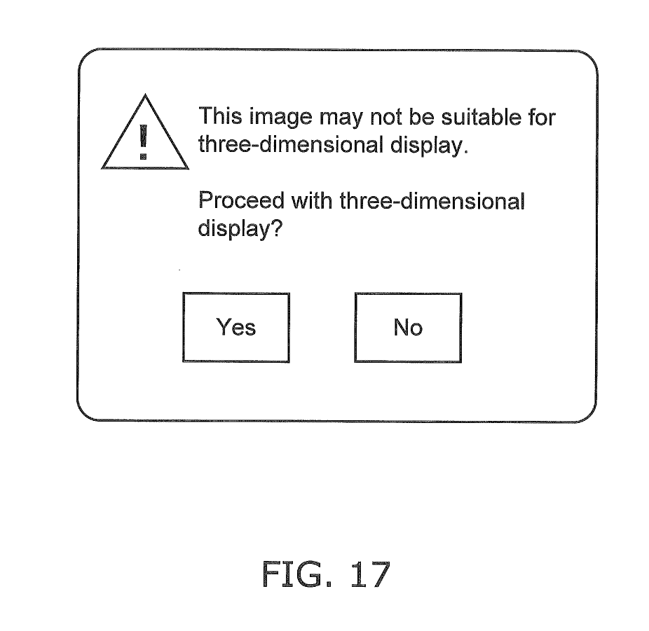

On the other hand, if the evaluation flag does indicate “low,” then the selected stereo image has a large amount of vertical relative deviation, which may make it difficult to obtain a good 3-D view, so a warning message is displayed by the display controller 125 on the camera monitor 120 (step S54). More specifically, as shown in FIG. 17, a warning message of “This image may not be suitable for three-dimensional display. Proceed with three-dimensional display?” is displayed on the camera monitor 120. The user uses the manipulation unit 130 to select either the “yes” or “no” displayed on the camera monitor 120. If the user selects “yes” (Yes in step S56), then the selected stereo image is three-dimensionally displayed on the camera monitor 120 (step S55). On the other hand, if the user selects “no” (No in step S56), the selected stereo image is not three-dimensionally displayed on the camera monitor 120, and the display returns to the thumbnails, for example. The processing of the above-mentioned steps S51 to S56 is executed every time the user selects a stereo image.

Thus, the display of stereo images not suited to three-dimensional display can be minimized, so a better 3-D view can be obtained.

Features of Camera Body

The features of the camera body 100 described above will now be discussed.

(1) With the camera body 100, the deviation amount calculator 155 evaluates the input image data (left-eye image data and right-eye image data) for suitability of three-dimensional display, and the evaluation information production section 156 produces evaluation information related to the suitability of three-dimensional display on the basis of the evaluation result of the deviation amount calculator 155. Further, evaluation information (an evaluation flag) is added to the input image data (left-eye image data and right-eye image data) by the metadata production section 147. As a result, if evaluation information added to the input image data is utilized, then whether or not the input image data is suited to three-dimensional display can be determined prior to its display, minimizing 3-D view with images not suited to three-dimensional display. Consequently, a better 3-D view can be obtained with this camera body 100.

(2) The deviation amount calculator 155 evaluates the suitability of three-dimensional display by performing pattern matching processing on the left-eye image data and right-eye image data included in input image data. More specifically, the deviation amount calculator 155 uses pattern matching processing to calculate the reference concordance C between the first image data PL equivalent to part of the left-eye image data and the second image data PR equivalent to part of the right-eye image data. Furthermore, the evaluation information production section 156 produces evaluation information (evaluation flags of “high,” “medium,” and “low”) on the basis of the reference concordance C. Since the reference concordance C is thus used to evaluate the suitability of three-dimensional display, this suitability can be easily evaluated.

(3) With this camera body 100, since the vertical relative deviation amounts DV for the left-eye image data and right-eye image data are calculated by the deviation amount calculator 155, the final extraction regions AL4 and AR4 can be decided on the basis of the vertical relative deviation amounts DV, and vertical relative deviation can be reduced in the left- and right-eye image data. Furthermore, since the final extraction regions AL4 and AR4 are decided on the basis of vertical relative deviation amounts DV calculated by pattern matching processing, the reference concordance C will be equivalent to the concordance of the left- and right-eye image data that is ultimately cropped out. Therefore, the accuracy of evaluation based on the reference concordance C can be further enhanced. That is, the vertical relative deviation can be effectively reduced while the evaluation of suitability of three-dimensional display can be carried out more accurately.

(4) Evaluation information is detected by the evaluation information determination section 158 from the inputted stereo image, and whether or not to display the stereo image three-dimensionally is determined by the display controller 125 on the basis of the detection result of the evaluation information determination section 158. Therefore, this evaluation information can be utilized to determine whether or not the input image data is suitable to three-dimensional display prior to its display, either automatically or by the user.

### Second Embodiment

In the first embodiment above, the calculation of the reference concordance C and the production of evaluation information are performed during a series of processing in which stereo image data is acquired, but it is also possible that the calculation of the reference concordance C and the production of evaluation information are performed on stereo image data that has already been acquired. Here, those components having substantially the same function as those in the first embodiment above are numbered the same and will not be described again in detail.

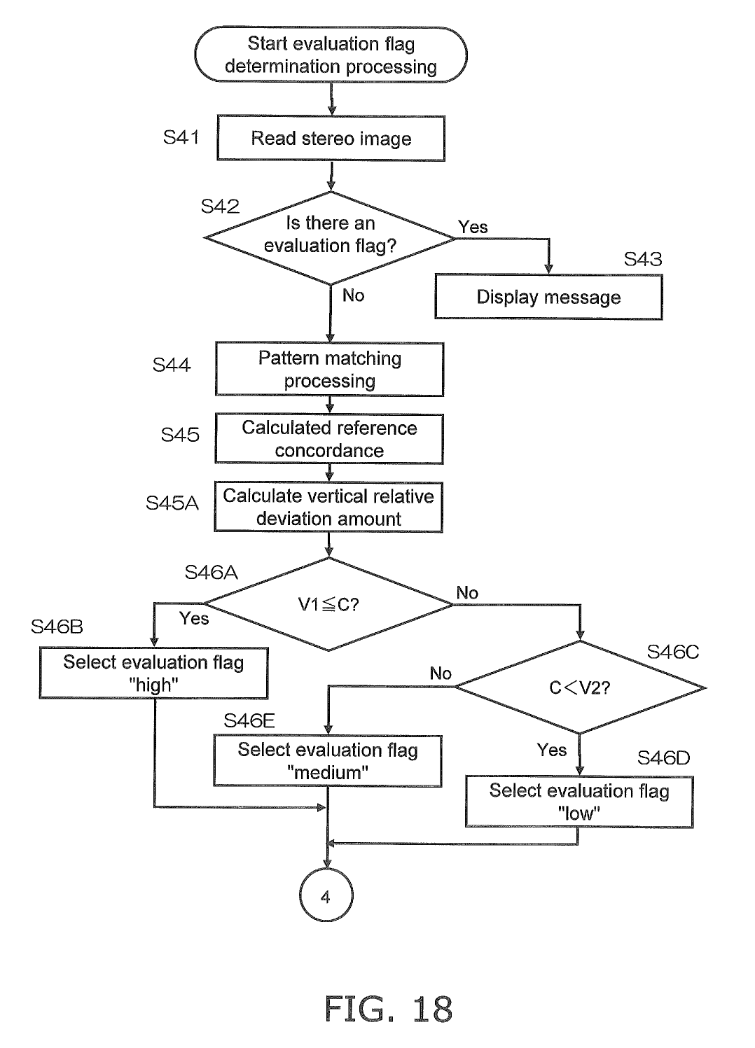

As shown in FIG. 18, the digital camera 1 has an evaluation flag production mode. In evaluation flag production mode, thumbnails of stereo images stored in the memory card 171 are displayed on the camera monitor 120. At this point, for example, the predetermined left-eye or right-eye image is displayed on the camera monitor 120 as a representative image. The user operates the manipulation unit 130 to select the stereo image to undergo evaluation flag production processing, whereupon the selected stereo image data is read to the DRAM 141 (step S41).

The evaluation information determination section 158 confirms whether or not evaluation information has been added as a flag to a specific region of the stereo image data (step S42). If there is an evaluation flag in the specific region, then there is no need to perform evaluation flag production processing, so a message to the effect that an evaluation flag has already been added, for example, is displayed on the camera monitor 120 (step S43).

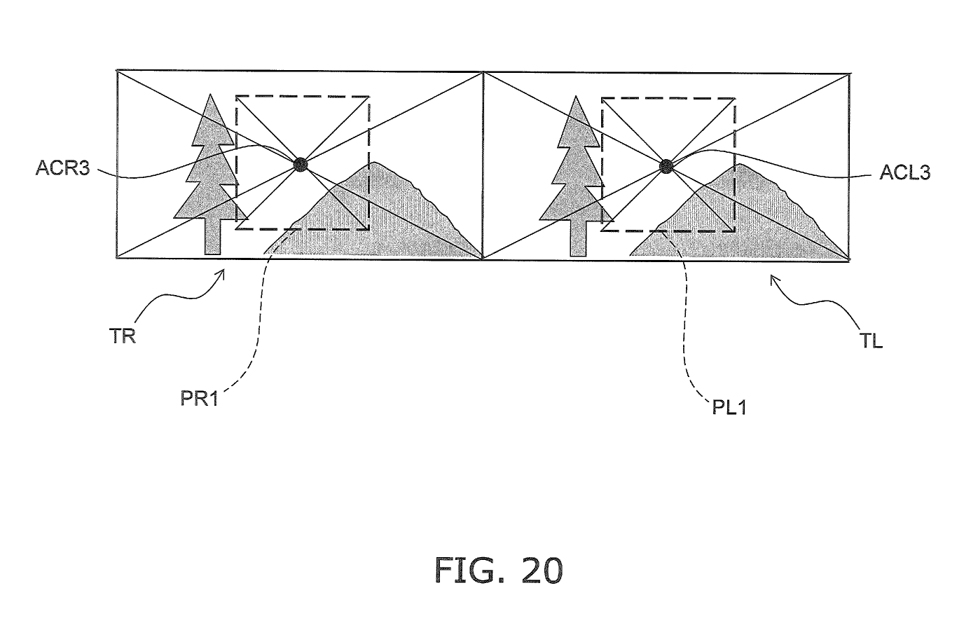

On the other hand, if there is no evaluation flag in the specific region, then just as in step S27 above, the stereo image data is subjected to pattern matching processing by the deviation amount calculator 155 (step S44). Furthermore, just as in step S28 above, the deviation amount calculator 155 calculates the reference concordance C, which indicates how well the images of the specific regions for left- and right-eye image data coincide, either during or after pattern matching processing (step S45). More precisely, the deviation amount calculator 155 subjects the regions of the left-eye image data TL and right-eye image data TR parts of the stereo image data to pattern matching processing, and the deviation amount calculator 155 calculates the reference concordance C for those regions. More specifically, as shown in FIG. 20, the deviation amount calculator 155 calculates the reference concordance C for an image of a predetermined region of the left-eye image data TL (first image data PL1) and an image of a predetermined region of the right-eye image data TR (second image data PR1). Here, unlike in the first embodiment above, the positions of the first image data PL1 and second image data PR1 are predetermined, but just as in the first embodiment, the image with the highest concordance with the first image data PL1 may be searched for among the right-eye image data TR. In this embodiment, the reference concordance C calculated by the deviation amount calculator 155 is temporarily stored in the DRAM 141 or the RAM 140c of the camera controller 140. Also, the vertical relative deviation amount DV for the left- and right-eye image data is calculated by the deviation amount calculator 155 during or after pattern matching processing (step S45A). The vertical relative deviation amount DV calculated by the deviation amount calculator 155 is temporarily stored in the DRAM 141 or the RAM 140c of the camera controller 140, for example.

Just as in steps S30A to S30E above, after pattern matching processing, evaluation information is produced by the evaluation information production section 156 on the basis of the reference concordance C calculated by the deviation amount calculator 155. More specifically, the reference concordance C is compared by the comparator 156a with a first reference value V1 and a second reference value V2 that have been preset. Furthermore, one piece of evaluation information is selected from among the evaluation information “high,” “medium,” and “low” by the production section 156b on the basis of the comparison result of the comparator 156a. The reference concordance C is compared with the first reference value V1 by the comparator 156a, and if the reference concordance C satisfies Conditional Formula 1 (Yes in step S46A), “high” is selected as the evaluation information by the production section 156b (step S46B).

On the other hand, if the reference concordance C does not satisfy Conditional Formula 1 (No in step S46A), the reference concordance C is compared by the comparator 156a with the second reference value V2 (step S46C). If the reference concordance C satisfies Conditional Formula 3 (Yes in step S46C), “low” is selected as the evaluation information by the production section 156b (step S46D). On the other hand, if the reference concordance C does not satisfy Conditional Formula 3 (No in step S46C), since the reference concordance C does satisfy the Conditional Formula 2, “medium” is selected as the evaluation information by the production section 156b (step S46E). The evaluation information selected by the production section 156b is temporarily stored in the DRAM 141 or the RAM 140c.

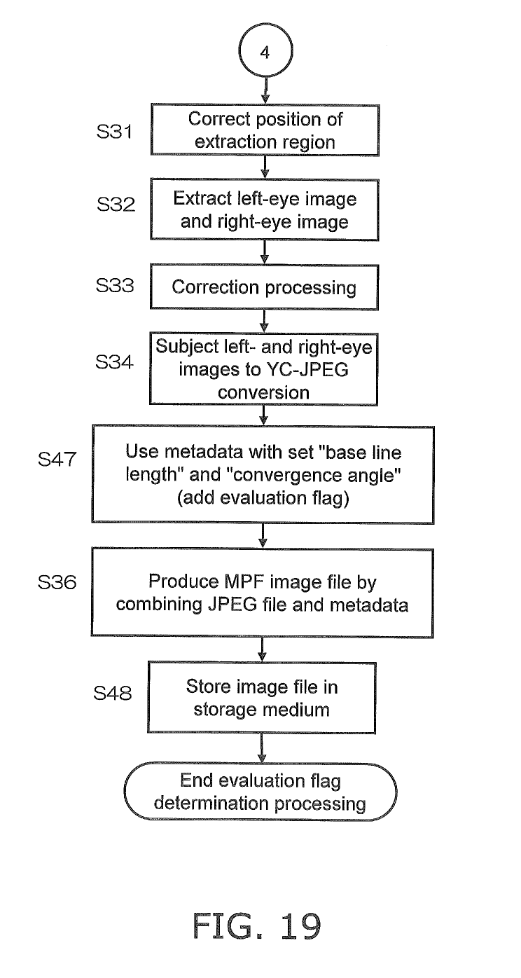

As shown in FIG. 19, after the production of evaluation information, processing is executed that is basically the same as in steps S31 to S37 above. More specifically, the positions of the extraction regions are decided by the region decision section 149 on the basis of the vertical relative deviation amounts DV calculated in step S45A (step S31). Here, the extraction regions are set to regions that are smaller than the original stereo image data, for example. Also, the shape of the extraction regions may be modified so that the newly decided extraction regions do not extend beyond the original stereo image. In this case, a black stripe is put in a region in which data is no longer present because the extraction region became smaller.

Furthermore, left-eye image data and right-eye image data are extracted from the basic image data by the image extractor 16 on the basis of the extraction regions AL4 and AR4 decided in step S31 (step S32). The correction processor 18 subjects the extracted left-eye image data and right-eye image data to correction processing (step S33).

The image compressor 17 performs JPEG compression or other such compression processing on the left-eye image data and right-eye image data (step S34).

After compression, the metadata production section 147 of the camera controller 140 produces metadata setting the stereo base and the convergence angle (step S35). More precisely, the stereo image metadata that is read is also used by the metadata production section 147. At this point an evaluation flag is added to a specific region of the metadata by the metadata production section 147 of the camera controller 140 (step S47).

After metadata production, the compressed left- and right-eye image data are combined with the metadata, and MPF image files are produced by the image file production section 148 (step S36). The produced image files are sent to the card slot 170 and stored in the memory card 171, for example (step S48).

Thus, pattern matching processing may be performed on stereo image data that has already been recorded, and the calculation of concordance, the production of evaluation information, and the addition of evaluation information may also be performed,

The image files produced in step S36 may be used only for display, and not stored.

### OTHER EMBODIMENTS

The present invention is not limited to or by the above embodiments, and various changes and modifications are possible without departing from the gist of the invention.

(A) An imaging device was described using as an example the digital camera 1 having no mirror box, but the image production device may also be a digital single lens reflex camera having a mirror box. In addition to being an image data that captures images as described in the third embodiment, the image production device may be one with which an image that has already been acquired is read and stored by overwriting, or with which a separate image can be newly produced, and an optical system or imaging element need not be installed. Furthermore, the image data may be one that is capable of capturing not only of still pictures, but also moving pictures.

(B) The interchangeable lens unit was described by using the interchangeable lens unit 200 as an example, but the constitution of the three-dimensional optical system is not limited to that in the above embodiments. As long as it is compatible with a single imaging element, the three-dimensional optical system may have some other configuration.

(C) In the above embodiments, an ordinary side-by-side imaging system was used as an example, but it is also possible to employ a horizontally compressed side-by-side imaging system in which the left- and right-eye images are compressed horizontally, or a rotation side-by-side imaging system in which the left- and right-eye images are rotated by 90 degrees.

(D) In FIG. 9 the image size is changed, but imaging may be prohibited if the imaging element is small. For example, the size of the extraction regions AL3 and AR3 is decided by the region decision section 149, but if the size of the extraction regions AL3 and AR3 drops below a specific size, a warning may be displayed to that effect on the camera monitor 120. Also, even if the size of the extraction regions AL3 and AR3 drops between a specific size, as long as the size of the extraction regions can be made relatively large by changing the aspect ratio of the extraction regions AL3 and AR3 (such as setting the aspect ratio to 1:1), then the aspect ratio may be changed.

(E) The above-mentioned interchangeable lens unit 200 may be a single focus lens. In this case, the extraction centers ACL2 and ACR2 can be found by using the above-mentioned extraction position correction amount L11. Furthermore, if the interchangeable lens unit 200 is a single focus lens, then zoom lenses 210L and 210R may be fixed, for example, and this eliminates the need for a zoom ring 213 and zoom motors 214L and 214R.

(F) With the above-mentioned pattern matching processing, the deviation amount calculator 155 searches for the matching region that best coincides with the image in the reference region within the extraction region AR3 on the basis of an image of a specific reference region within the extraction region AL3, but the pattern matching processing may entail some other method.

(G) In the above embodiments, the production of evaluation information is performed using the reference concordance C as a reference, but the production of evaluation information may instead be performed using the concept of discrepancy. When evaluation information is produced using a reference discrepancy D, Conditional Formulas 1 to 3 become the following Conditional Formulas 11 to 13, for example.

evaluation flag “high”: V11≧D (11)

evaluation flag “medium”: V12≧D>V11 (12)

evaluation flag “low”: D>V12 (13)

If the numerical value indicating concordance is not a reciprocal, then that numerical value is equivalent to discrepancy, and Conditional Formulas 11 and 12 will be used. Also, the types of evaluation information and the quantity of the reference value are not limited to what was given in the above embodiments. For example, there may be two types of evaluation information, or there may be four or more types. Also, the reference value may be one, or may be three or more.

(H) In the above embodiments, an evaluation flag is added to a specific region within metadata by the metadata production section 147, and the metadata is added to the left- and right-eye image data by the image file production section 148. However, the method for adding an evaluation flag is not limited to this.

(I) In the above embodiments, the detection region used in pattern matching processing is decided on the basis of the left-eye deviation amount DL and right-eye deviation amount DR acquired from the interchangeable lens unit by the characteristic information acquisition section 143, but the positions of the extraction regions may be decided by just the vertical relative deviation amount DV calculated by the deviation amount calculator 155.

(J) The phrase “suitability of three-dimensional imaging” indicates whether or not a good 3-D view can be obtained in a three-dimensional display. Therefore, the suitability of three-dimensional display is decided, for example, by the relative deviation amount of the left-eye image data and right-eye image data in the input image data (the relative deviation amount in the vertical and/or horizontal direction). The amount of relative deviation in the horizontal direction may include parallax, but if the amount of relative deviation in the horizontal direction is large, it may hinder obtaining a good 3-D view, so the amount of relative deviation in the horizontal direction, and not just that in the vertical direction, can also affect the suitability of three-dimensional display.

(K) In the above embodiments, the stereo image is acquired using the side-by-side imaging system. More specifically, the left-eye image data is acquired on the basis of the left-eye optical image QL1 formed by the left-eye optical system OL, and the right-eye image data is acquired on the basis of the right-eye optical image QR1 formed by the right-eye optical system OR. Even if the left-eye image data and the right-eye image data are acquired by serially taking pictures with panning, however, the above technology can be used.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An image production device comprising:
a deviation detecting device configured to calculate the amount of relative deviation of left-eye image data and right-eye image data included with input image data; and
an information production section configured to produce evaluation information related to the suitability of three-dimensional imaging based on reference information produced by the deviation detecting device which calculates the relative deviation amount.

2. The image production device according to claim 1, further comprising
an information adder configured to add the evaluation information to the input image data.

3. The image production device according to claim 2, wherein
the deviation detecting device produces the reference information by performing pattern matching processing on the left-eye image data and right-eye image data.

4. The image production device according to claim 1, wherein
the deviation detecting device is further configured to use a pattern matching process to calculate as the reference information the concordance between first image data which corresponds to at least part of the left-eye image data and second image data which corresponds to at least part of the right-eye image data, and
the information production section is further configured to produce the evaluation information based on the concordance between the first image data and the second image data.

5. The image production device according to claim 2, further comprising
an information identification section configured to detect the evaluation information from inputted stereo image data.

6. The image production device according to claim 5, further comprising
a display identification section configured to identify whether the stereo image data can be displayed in three-dimensional based on the detection results of the information identification section.

7. The image production device according to claim 4, wherein
the information production section includes a comparator a production section, the comparator is configured to compare the concordance between the first image date and the second image with a preset reference value, and the production section is configured to produce the evaluation information based on the results of the comparator.

8. An image production method comprising:
calculating the amount of relative deviation of left-eye image data and right-eye image data included with input image data; and
producing evaluation information related to the suitability of three-dimensional imaging based on reference information produced by a deviation detecting device configured to calculate the relative deviation amount.

9. The method according to claim 8, wherein
the calculating the amount of relative deviation includes using a deviation detecting device, and
the producing evaluation information related to the suitability of three-dimensional imaging includes using an information production section.

10. A program configured to cause a computer to perform the processes of:
calculating the amount of relative deviation of left-eye image data and right-eye image data included with input image data using a deviation detecting device coupled to the computer; and
producing evaluation information related to the suitability of three-dimensional imaging using an information production section coupled to the computer and based on reference information produced by the deviation detecting device which calculates the relative deviation amount.

11. A computer-readable storage medium having a computer-readable program stored thereon, the computer-readable storage medium being coupled to a computer to cause the computer to perform the processes of:
calculating the amount of relative deviation of left-eye image data and right-eye image data included with input image data using a deviation detecting device coupled to the computer; and
producing evaluation information related to the suitability of three-dimensional imaging using an information production section coupled to the computer and based on reference information produced by the deviation detecting device which calculates the relative deviation amount.

12. The computer-readable storage medium according to claim 11, wherein
the computer-readable storage medium is a removable disk drive.
